(19) United States
(12) Patent Application Publication
(10) Pub. No.: US 2009/0143502 A1
(43) Pub. Date: Jun. 4, 2009

(54) Aqueous dispersions utilizing carboxyalkyl cellulose esters and water reducible polymers

(75) Inventor: Ronald Obie, High Point, NC (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Wood Coatings Research Group, Inc., Greensboro, NC (US)

(21) Appl. No.: 11/988,664

(22) PCT Filed: Jul. 11, 2006
(86) PCT No.: PCT/US06/27012

§ 371 Date: Jan. 11, 2008

Related U.S. Application Data
(60) Provisional application No. 60/697,538, filed on Jul. 11, 2005.

(51) Int. Cl. C09D 101/00; C08L 1/32; C08L 1/00; C08G 18/08; C08L 9/00; C08L 39/00; C08F 2/32; C09D 101/32

(52) U.S. Cl. 524/37; 106/168.01; 106/170.57; 106/170.55; 524/800; 524/801; 524/591; 524/555; 524/573; 524/577

(57) ABSTRACT

Aqueous dispersions containing hydrophobic materials that are useful as reduced volatile organic content may be utilized as a coating, a stain, a resin, a polymer, or an additive. Specifically, the aqueous dispersion may contain one or more of a carboxyalkyl cellulose ester, such as carboxymethyl cellulose acetate butyrate, a fluorosurfactant, such as a polyoxetane fluorosurfactant or a fluoroaliphatic polymeric ester based surfactant, a water dispersible resin, and optionally, a C-11 ketone and/or surfactant.

### CROSS-REFERENCE TO RELATED APPLICATION

This application claims the benefit of U.S. Provisional Patent Application No. 60/697,538, filed Jul. 11, 2005, herein incorporated by reference.

### BACKGROUND OF THE INVENTION

### Field of the Invention

Aqueous dispersions containing hydrophobic materials that are useful as reduced volatile organic content may be utilized as a coating, a stain, a resin, a polymer, or an additive. Specifically, the aqueous dispersion may contain one or more of a carboxyalkyl cellulose ester, such as carboxymethyl cellulose acetate butyrate, a fluorosurfactant, such as a polyoxetane fluorosurfactant or a fluoroaliphatic polymeric ester based surfactant, a water dispersible resin, and optionally, a C-11 ketone and/or surfactant.

### BRIEF SUMMARY OF THE INVENTION

The invention provides an aqueous dispersion of a hydrophobic material that may be utilized as a stain, resin, coating, polymer, or an additive.

In one embodiment of the invention, the aqueous dispersion comprises a carboxyalkyl cellulose ester, a fluorosurfactant, and a hydrophobic material. In another embodiment of the invention, the aqueous dispersion optionally includes C-11 ketone. In yet another embodiment of the invention, the aqueous dispersion optionally includes a surfactant.

In a second embodiment of the invention, the invention is directed to a method for dispersing a hydrophobic material in water, comprising: (a) dissolving a carboxyalkyl cellulose ester and a fluorosurfactant in a compatible solvent; (b) adding the hydrophobic material; (c) neutralizing the carboxyalkyl cellulose ester with a base; and (d) adding water, so as to invert the resulting mixture from a solvent continuous phase to an aqueous continuous phase. In another embodiment of the invention, the method additionally comprises optionally dissolving C-11 ketone with the carboxyalkyl cellulose ester and fluorosurfactant in a compatible solvent. In yet another embodiment of the invention, the method additionally comprises optionally including a surfactant with the carboxyalkyl cellulose ester and fluorosurfactant in a compatible solvent.

In a third embodiment of the invention, the invention is directed to an aqueous coating composition comprising an aqueous dispersion comprising a carboxyalkyl cellulose ester, a fluorosurfactant, and a hydrophobic material. In another embodiment of the invention, the aqueous dispersion of the aqueous coating composition optionally includes C-11 ketone. In yet another embodiment, the aqueous dispersion of the aqueous coating composition optionally includes a surfactant.

In a fourth embodiment of the invention, the invention is directed to an article coated with an aqueous coating composition comprising a carboxyalkyl cellulose ester, a fluorosurfactant, and a hydrophobic material. In another embodiment of the invention, the aqueous dispersion of the aqueous coating composition optionally includes C-11 ketone. In yet another embodiment of the invention, the aqueous dispersion of the aqueous coating composition comprises optionally includes a surfactant.

In a fifth embodiment of the invention, the aqueous dispersion comprises a carboxyalkyl cellulose ester, a water dispersible resin, and a hydrophobic material. In another embodiment of the invention, the aqueous dispersion additionally comprises a fluorosurfactant. In yet another embodiment of the invention, the aqueous dispersion composition optionally includes C-11 ketone. In still yet another embodiment of the invention, the aqueous dispersion optionally includes a surfactant.

In a sixth embodiment of the invention, the invention is directed to a method for dispersing a hydrophobic material in water, comprising (a) dissolving a carboxyalkyl cellulose ester and a water dispersible resin in a compatible solvent; (b) adding the hydrophobic material; (c) neutralizing the carboxyalkyl cellulose ester and water dispersible resin to some percent neutralization with a base; and (d) adding water, so as to invert the resulting mixture from a solvent continuous phase to an aqueous continuous phase. In another embodiment of the invention, the method additionally comprises dissolving a fluorosurfactant with the carboxyalkyl cellulose ester and the water dispersible resin in a compatible solvent. In yet another embodiment of the invention, the method optionally comprises dissolving C-11 ketone with the carboxyalkyl cellulose ester, the water dispersible resin, and fluorosurfactant in a compatible solvent. In still yet another embodiment of the invention, the method optionally comprises adding a surfactant with the carboxyalkyl cellulose ester, the water dispersible resin, and fluorosurfactant in a compatible solvent.

In a seventh embodiment of the invention, the invention is directed to an aqueous coating composition comprising an aqueous dispersion comprising a carboxyalkyl cellulose ester, a water dispersible resin, and a hydrophobic material. In another embodiment of the invention, the aqueous dispersion of the aqueous coating composition comprises a fluorosurfactant. In yet another embodiment of the invention, the aqueous dispersion of the aqueous coating composition optionally includes C-11 ketone. In still yet another embodiment of the invention, the aqueous dispersion of the aqueous coating composition optionally includes a surfactant.

In an eighth embodiment of the invention, the invention is directed to an article coated with an aqueous coating composition comprising a carboxyalkyl cellulose ester, a water dispersible resin, and a hydrophobic material. In another embodiment of the invention, the aqueous dispersion of the aqueous coating composition comprises a fluorosurfactant. In yet another embodiment of the invention, the aqueous dispersion of the aqueous coating composition optionally includes C-11 ketone. In still yet another embodiment of the invention, the aqueous dispersion of the aqueous coating composition optionally includes a surfactant.

In a ninth embodiment of the invention, the invention is directed to a method of dispersing hydrophobic materials into water comprising (a) charging the water dispersible resin to the mixing vessel, (b) adding the hydrophobic material, (c) neutralizing the water dispersible material to the appropriate percent neutralization with a base; and (d) adding water, so as to invert the resulting mixture from a solvent continuous phase to an aqueous continuous phase. In another embodiment of the invention, the method additionally comprises dissolving a fluorosurfactant with the water dispersible resin. In yet another embodiment of the invention, the method optionally comprises dissolving C-11 ketone with the water dispersible resin and fluorosurfactant in a compatible solvent. In still yet another embodiment of the invention, the method optionally comprises adding a surfactant to the water dispersible resin and fluorosurfactant in a compatible solvent.

In a tenth embodiment of the invention, the invention is directed to an aqueous coating composition comprising an aqueous dispersion comprising a water dispersible resin and a hydrophobic material. In another embodiment of the invention, the aqueous dispersion of the aqueous coating composition additionally comprises a fluorosurfactant. In yet another embodiment of the invention, the aqueous dispersion of the aqueous coating composition optionally includes C-11 ketone. In still yet another embodiment of the invention, the aqueous dispersion of the aqueous coating composition optionally includes a surfactant.

In an eleventh embodiment of the invention, the invention is directed to an article coated with an aqueous coating composition comprising a water dispersible resin and a hydrophobic material. In another embodiment of the invention, the aqueous dispersion of the aqueous coating composition additionally comprises a fluorosurfactant. In yet another embodiment of the invention, the aqueous dispersion of the aqueous coating composition optionally includes C-11 ketone. In still yet another embodiment of the invention, the aqueous dispersion of the aqueous coating composition optionally includes a surfactant.

In a twelfth embodiment of the invention, the invention is directed to a dispersant system comprising a carboxyalkyl cellulose ester and a fluorosurfactant, wherein the dispersant system is capable of dispersing a hydrophobic material. In another embodiment of the invention, the aqueous dispersant system optionally includes C-11 ketone. In yet another embodiment of the invention, the aqueous dispersant system optionally includes a surfactant.

Various embodiments of the invention are described below. Any of the embodiments of the invention may be used alone, or may be taken in various combinations. Some of the combinations according to the invention may be used to formulate coating compositions having unexpected properties in view of the state of the art, and are intended to be encompassed within the scope of the invention. Additional objects and advantages of the invention are discussed in the detailed description that follows, and will be obvious from that description, or may be learned by practice of the invention. It is to be understood that both this summary and the following detailed description are exemplary and explanatory only, and are not intended to restrict the scope of the invention.

### BRIEF DESCRIPTION OF THE FIGURES

The accompanying figures, which are incorporated herein and form a part of the specification, illustrate the present invention and, together with the description, further serve to explain the principles of the invention and to enable a person skilled in the pertinent art to make and use the invention.

FIG. 1A. Illustrates the film draw down appearance of Example 20.

FIG. 1B. Illustrates the film draw down appearance of Example 23.

FIG. 1C. Illustrates the film draw down appearance of Example 21.

FIG. 1D. Illustrates the film draw down appearance of Example 22.

FIG. 2A. Illustrates the particle size of Example 20 by optical analysis at 200× magnification of the samples sandwiched between the microscope slide and cover slip for approximately 4 hours.

FIG. 2B. Illustrates the particle size of Example 20 by optical analysis at 400× magnification of the samples sandwiched between the microscope slide and cover slip for approximately 4 hours.

FIG. 2C. Illustrates the particle size of Example 23 by optical analysis at 400× magnification of the samples sandwiched between the microscope slide and cover slip for approximately 4 hours.

FIG. 2D. Illustrates the particle size of Example 21 by optical analysis at 400× magnification of the samples sandwiched between the microscope slide and cover slip for approximately 4 hours.

FIG. 2E. Illustrates the particle size of Example 22 by optical analysis at 400× magnification of the samples sandwiched between the microscope slide and cover slip for approximately 4 hours.

FIGS. 3A and 3B. Images of the particle size of the dispersion of Example 38C at 400× magnification with transmitted light, as described in Example 38.

FIGS. 4A and 4B. Images of the particle size of the dispersion of Example 38B at 400× magnification with transmitted light.

FIGS. 5A and 5B. Images of the particle size of the dispersion of Example 38A at 400× magnification with transmitted light.

### DETAILED DESCRIPTION OF THE INVENTION

The invention provides an aqueous dispersion of a hydrophobic material that may be utilized as a stain, resin, coating, polymer, or an additive.

In one embodiment of the invention, the aqueous dispersion comprises a carboxyalkyl cellulose ester, a fluorosurfactant, and a hydrophobic material.

The term “aqueous dispersion” is intended to encompass compositions containing an aqueous phase (e.g., water) as a continuous phase within which is dispersed a solid, liquid or polymeric phase. This solid, liquid, or polymeric phase becomes the discontinuous phase of the composition.

The term “hydrophobic material” is intended to encompass hydrophobic resins and moieties that can be incorporated into aqueous compositions of the invention that result in dispersions that may be utilized as a stain, resin, coating, polymer, or an additive.

The term “aqueous coating composition” is intended to encompass compositions containing an aqueous phase (e.g., water) that are applied to substrates.

Suitable carboxyalkyl cellulose esters for the invention are selected from a group consisting of carboxymethyl cellulose butyrate, carboxymethyl cellulose propionate, carboxymethyl cellulose acetate butyrate, and carboxymethyl cellulose acetate propionate. In one embodiment of the invention, the dispersion comprises certain esters of carboxy (C₁-C₃ alkyl) cellulose such as those taught in U.S. Pat. Nos. 5,668,273; 5,994,530; and 7,026,470 B2, and WO 01/35719.

In another embodiment, the carboxylmethyl cellulose ester of the invention comprises a carboxymethyl cellulose acetate butyrate “CMCAB”, having a degree of substitution of carboxymethyl of about 0.20 to about 0.75, a degree of substitution per anhydroglucose unit of hydroxyl from about 0.10 to about 0.70, and a degree of substitution per anhydroglucose unit of butyryl of about 0.10 to about 2.60 and a degree of substitution per anhydroglucose unit of acetyl of about 0.10 to about 1.65, and having an inherent viscosity of about 0.20 to about 1.70 dL/g, as measured in a 60/40 (wt/wt) solution of phenol/tetrachloroethane at 25° C. In yet another embodiment, the CMCAB has a degree of substitution carboxymethyl of about 0.25 to about 0.35, a degree of substitution per anhydroglucose unit of hydroxyl from about 0.10 to about 0.70, and a degree of substitution per anhydroglucose unit of butyryl of about 0.10 to about 2.60 and a degree of substitution per anhydroglucose unit of acetyl of about 0.10 to about 1.65, and having an inherent viscosity of about 0.20 to about 1.70 dL/g, as measured in a 60/40 (wt/wt) solution of phenol/tetrachloroethane at 25° C. In yet another embodiment, the CMCAB has a degree of substitution per anhydroglucose unit of hydroxyl of about 0.10 to about 0.70, butyryl of about 1.10 to about 2.55, and acetyl of about 0.10 to about 0.90.

Incorporation of the fluorosurfactant in the dispersant system results in improved dispersion processing, reduced foaming characteristics, improved dispersion appearance and stability, and decreased dispersion particle size. Suitable fluorosurfactants include, but are not limited to, one or more of polyoxetane fluorosurfactants and fluoroaliphatic polymeric esters. In one embodiment, these fluorosurfactants may be short chain, (four carbons or less). Examples of suitable polyoxetane fluorosurfactants include, but are not limited to, those described in WO2002/092660, WO2003/051959, WO2006/065752, WO2001/048051, and U.S. Pat. Nos. 6,403,760 and 6,660,828. In particular, WO2006/065752 discloses short chain fluorinated polyether block copolymers which result in small micelle particle size, a property which is beneficial in the current invention. More specifically, WO2006/065752 discloses block copolymers that include a first polyether block having a pendant alkoxyfluoroalkyl group and a second polyether block substantially devoid of pendant alkoxyfluoroalkyl groups. Other suitable polyoxetane fluorosurfactants include commercially available products such as PolyFox™ PF-151N, PolyFox™ PF-159, PolyFox™ PF-154N, and PolyFox™ PF-3320 (Omnova Solutions, Fairlawn, Ohio). Other fluorinated surfactants useful for the invention include, but are not limited to, commercially available fluoroaliphatic polymeric esters such as the FC-4430, FC-4432, and FC-4434 (3M Company, Minneapolis, Minn.).

The aqueous dispersion of the present invention includes a hydrophobic material. Examples of suitable hydrophobic materials that may be used include, but are not limited to, one or more of a wax, a silicone, a silicone wax, a fluorocarbon, a UV absorber, a photoinitiator, a chlorinated polyolefin, a nonchlorinated polyolefin, a hydroxy-functional polymer, a silanol modified polyol, an acrylic, a polyester, a polyether, an acrylate-functional resin, an acrylated acrylic, an acrylated polyester, an acrylated polyether, an acrylated polyurethane, an acrylated epoxy, an amine-modified acrylated acrylic, an amine-modified polyester, an amine-modified polyether, an unsaturated polyester, an allyl-functional polymer, styrene allyl alcohol, a non-water soluble polyol, an air-oxidizable initiator/crosslinker, a phenoplast resin, a hydrocarbon resin, a polyvinyl butyral resin, a polybutadiene resin, a modified polybutadiene resin, an aminoplast resin, an oil, a fat, a fatty acid, a resin derived from an oil, fat, or fatty acid, a plasticizer, a hydroxyl-terminated polybutadiene resin or derivative thereof, a maleic-modified resin, an ethylene vinyl acetate copolymer, a styrene-butadiene copolymer, a styrene-isoprene copolymer, an acrylic copolymer, an alkyd resin, a modified alkyd resin including styrene, vinyl toluene and urethane-modified alkyds, a fluorinated acrylic, and an aliphatic or aromatic hydrocarbon resin.

Additionally, oils and fats and resins derived therefrom can be used as part of the hydrophobic moiety of the invention. Examples of suitable oils and resins derived therefrom include, but are not limited to, those described in Bailey's Industrial Oil and Fat Pioducts, Volume 1, 4th ed., Swern, D., ed., John Wiley & Sons, New York, N.Y. Other hydrophobic moieties that may be dispersed with the invention include defoamers (e.g., silicone), antioxidants, waxes, colorants, pigments, dyes, dispersants, UV absorbers, light stabilizers, catalysts, crosslinkers, biocides, flow and leveling agents, wetting agents, sunscreens, and water repellants.

Still other hydrophobic moieties that can be incorporated into the aqueous dispersions, coating compositions, and additives according to the invention include the resins and additives described in WO 2004/030801, such as, for example, different types of silicones, waxes, chlorinated polymers, polyols/hydroxyl functional polymers, unsaturated and UV-curable resins and oligomers, photoinitiators, additives stabilizers, and aminoplast and phenoplast resins.

In another embodiment of the invention, the aqueous dispersion optionally includes C-11 ketone. An example of one suitable C-11 ketone is CAS number 71808-49-6.

In another embodiment of the invention, the aqueous dispersion optionally includes a surfactant. Examples of suitable surfactants include, but are not limited to, one or more nonionic surfactants, such as acetylenic glycol based surfactants, polyalkylene glycol ethers, aliphatic alcohol ethoxylates, alkylphenol ethoxylates, tristyrylphenol ethoxylates, block copolymers such as ethoxylated polyoxypropylenes, the nonionic ADEX brand of surfactants (Rhodia, Polymer System Specialties, Cranbury, N.J.) and surfactant blends such as Carbowet DC01 (Air Products and Chemicals, Allentown, Pa.). Other surfactants useful for the invention include those mentioned in Rosen, M. J., Surfactants and Interfacial Phenomena, 3rd ed., John Wiley & Sons, New York, N.Y.; (2004) and Möbius, D., et al., Surfactant: Chemistry, Interfacial Properties, Applications (Studies in Interface Science), Bk&CD-Rom edition, Elsevier Science BV, Amsterdam, The Netherlands (2001).

In a second embodiment of the invention, the invention is directed to a method for dispersing a hydrophobic material in water, comprising: (a) dissolving a carboxyalkyl cellulose ester and a fluorosurfactant in a compatible solvent; (b) adding the hydrophobic material; (c) neutralizing the carboxyalkyl cellulose ester with a base; and (d) adding water with sufficient agitation, so as to invert the resulting mixture from a solvent continuous phase to an aqueous continuous phase. In another embodiment of the invention, the method additionally comprises optionally dissolving C-11 ketone with the carboxyalkyl cellulose ester and fluorosurfactant in a compatible solvent.

In another embodiment of the invention, the method additionally comprises optionally including a surfactant with the carboxyalkyl cellulose ester and fluorosurfactant and/or C-11 ketone in a compatible solvent. Examples of typical solvents useful for the invention include, but are not limited to, acetone, methyl ethyl ketone, methyl isobutyl ketone, methyl amyl ketone, methyl isoamyl ketone, 2-propoxy-ethanol, 2-butoxyethanol, ethyl 3-ethoxypropionate, 2-butanone, methanol, ethanol, propanol, isopropyl alcohol, butanol, 2-ethyl-hexanol, ethyl acetate, propyl acetate, isopropyl acetate, butyl acetate, isobutyl acetate, tertiary butyl acetate, ethyl ether, propyl ether, propyl glycol butyl ether, diethylene glycol methyl ether, diethylene glycol ethyl ether, diethylene butyl ether, dipropylene glycol ether, dipropylene glycol methyl ether, ethylene glycol, ethylene glycol butyl ether, ethylene glycol diethyl ether, ethylene glycol dimethyl ethyl ether, ethylene glycol ethyl ether, ethylene glycol 2-ethylhexyl ether, ethylene glycol methyl ether, ethylene glycol phenyl ether, 1-methyl-2-pyrrolidinone, ethylene glycol diacetate, ethylene glycol monoethyl ether, ethylene glycol monopropyl ether, ethylene glycol monobutyl ether, ethyl ether, propylene glycol butyl ether, propylene glycol dimethyl ether, propylene glycol ethyl ether acetate, propylene glycol methyl ether, propylene glycol ethyl ether, propylene glycol, propylene glycol butyl ether, propylene glycol methyl ether acetate, propylene glycol phenyl ether, propylene glycol propyl ether, tripropylene glycol ethyl ether, triethylene glycol, tri(ethylene glycol) dimethyl ether, and mixtures thereof. Other suitable solvents include those listed in Wypych, G., ed., Handbook of Solvents, ChemTec Publishing, Ontario, Canada (2001) and Swaraj, P., Surface Coatings Science and Technology, 2nd ed. John Wiley & Sons, New York, N.Y. (1996). Other volatile inert solvents typically used in coating compositions may also be used in the aqueous dispersions of the present invention, as will be apparent to one of ordinary skill in the art. Typically, the amount of solvent will be adjusted to dissolve and/or suspend the various components of the composition in a uniform liquid suspension or liquid. Typically, the amount of solvent will be kept as low as possible in order to keep the volatile organic compound “VOC” of the composition as low as possible.

In a third embodiment of the invention, the invention is directed to an aqueous coating composition comprising an aqueous dispersion comprising a carboxyalkyl cellulose ester, a fluorosurfactant, and a hydrophobic material. In another embodiment of the invention, the aqueous dispersion of the aqueous coating composition optionally includes C-11 ketone. In another embodiment of the invention, the aqueous dispersion of the aqueous coating composition optionally includes a surfactant.

The aqueous dispersions of the present invention may be utilized in a coating, a stain, a resin, a polymer, or an additive. Illustrative coatings that can utilize the composition of the invention include wood coatings such as, e.g., stains, seal coat/sealers, topcoats, wiping stains, glazes, and fillers. Examples of other coatings include paper coatings, cardboard coatings, paints (e.g., house paints), primers, architectural coatings, industrial coatings, maintenance coatings, general metal-type coatings, paper coatings including textile treatments, plastic coatings such as primers, base coats, top coats, antigraffiti coatings, UV coatings, and adhesion promoters, and polishes. Other suitable coatings that may include the aqueous coating compositions of the invention can be found in Flick, E. W., Paint & Ink Formulation Database, William Andrew Publishing, Norwich, N.Y. (2005), Lambourne, R. and Strivens, T. A., eds., Paint and Surface Coatings: Theory and Practice, 2nd ed., 1999; William Andrew Publishing, Norwich, N.Y. (1999), and Wicks, Z. W., et al., eds., Organic Coatings: Science and Technology, 2nd ed., John Wiley & Sons, New York, N.Y. (1999).

In a fourth embodiment of the invention, the invention is directed to an article coated with an aqueous coating composition comprising a carboxyalkyl cellulose ester, a fluorosurfactant, and a hydrophobic material. In another embodiment of the invention, the aqueous dispersion of the aqueous coating composition optionally includes C-11 ketone. In yet another embodiment of the invention, the aqueous coating composition optionally includes a surfactant.

In a fifth embodiment of the invention, the aqueous dispersion comprises a carboxyalkyl cellulose ester, a water dispersible resin, and a hydrophobic material. In another embodiment of the invention, the aqueous dispersion additionally comprises a fluorosurfactant. In yet another embodiment of the invention, the aqueous dispersion optionally includes C-11 ketone. In still yet another embodiment of the invention, the aqueous dispersion optionally includes a surfactant.

The use of the water dispersible resin in place of all or a portion of the carboxyalkyl cellulose ester is advantageous in that its use results in dramatically reduced volatile organic compounds (“VOCs”).

Suitable water dispersible resins for use in the aqueous dispersion of the invention include, but are not limited to, one or more olefinic copolymers.

In one embodiment, the olefinic copolymer is one or more of hydroxyl functional acrylics or polyesters having hydrophilizing functionality. U.S. Pat. No. 5,466,745 discloses olefinic copolymers with an average molecular weight of about 1000 to about 50000, an acid number of from about 15 to about 150 mg KOH/g resin, and an amount of hydroxyl groups of from about 2.5 wt % to about 6 wt % (on a 100% solids basis). Fiori, D, et al., in “The Effect of Particle Size Distribution on the Performance of Two-Component Water Reducible Acrylic Polyurethane Coatings Using Tertiary Polyisocyanate Crosslinkers,” Journal of Coatings Technology 72 (2000) further describe olefinic copolymers that are useful for the invention.

In a sixth embodiment of invention, the invention is directed to a method for dispersing a hydrophobic material in water, comprising (a) dissolving a carboxyalkyl cellulose ester and a water dispersible resin in a compatible solvent; (b) adding the hydrophobic material; (c) neutralizing the carboxyalkyl cellulose ester and water dispersible resin to some percent neutralization with a base; and (d) adding water with sufficient agitation, so as to invert the resulting mixture from a solvent continuous phase to an aqueous continuous phase. In another embodiment of the invention, the method additionally comprises dissolving a fluorosurfactant with the carboxyalkyl cellulose ester and the water dispersible resin in a compatible solvent. In yet another embodiment of the invention, the method optionally comprises dissolving C-11 ketone with the carboxyalkyl cellulose ester, the water dispersible resin, and fluorosurfactant in a compatible solvent. In yet another embodiment of the invention, the method optionally comprises adding a surfactant with the carboxyalkyl cellulose ester, the water dispersible resin, and fluorosurfactant in a compatible solvent.

In a seventh embodiment of the invention, the invention is directed to an aqueous coating composition comprising an aqueous dispersion comprising a carboxyalkyl cellulose ester, a water dispersible resin, and a hydrophobic material. In another embodiment of the invention, the aqueous dispersion of the aqueous coating composition comprises a fluorosurfactant. In yet another embodiment of the invention, the aqueous dispersion of the aqueous coating composition optionally includes C-11 ketone. In still yet another embodiment of the invention, the aqueous dispersion of the aqueous coating composition optionally includes a surfactant.

In an eighth embodiment of the invention, the invention is directed to an article coated with an aqueous coating composition comprising a carboxyalkyl cellulose ester, a water dispersible resin, and a hydrophobic material. In another embodiment of the invention, the aqueous dispersion of the aqueous coating composition comprises a fluorosurfactant. In yet another embodiment of the invention, the aqueous dispersion of the aqueous coating composition optionally includes C-11 ketone. In still yet another embodiment of the invention, the aqueous dispersion of the aqueous coating composition optionally includes a surfactant.

In a ninth embodiment of the invention, the invention is directed to a method of dispersing hydrophobic materials into water comprising (a) charging the water dispersible resin to the mixing vessel, (b) adding the hydrophobic material, (c) neutralizing the water dispersible material to the appropriate percent neutralization with a base; and (d) adding water with sufficient agitation, so as to invert the resulting mixture from a solvent continuous phase to an aqueous continuous phase. In another embodiment of the invention, the method additionally comprises dissolving a fluorosurfactant with the water dispersible resin. In yet another embodiment of the invention, the method optionally comprises dissolving C-11 ketone with the water dispersible resin and fluorosurfactant in a compatible solvent. In still yet another embodiment of the invention, the method optionally comprises the addition of a surfactant with the water dispersible resin and fluorosurfactant in a compatible solvent.

In a tenth embodiment of the invention, the invention is directed to an aqueous coating composition comprising an aqueous dispersion comprising a water dispersible resin and a hydrophobic material. In another embodiment of the invention, the aqueous dispersion of the composition additionally comprises a fluorosurfactant. In yet another embodiment of the invention, the aqueous dispersion of the composition optionally includes C-11 ketone. In still yet another embodiment of the invention, the aqueous dispersion of the composition optionally includes a surfactant.

In an eleventh embodiment of the invention, the invention is directed to an article coated with an aqueous coating composition comprising a water dispersible resin and a hydrophobic material. In another embodiment of the invention, the aqueous dispersion of the aqueous coating composition additionally comprises a fluorosurfactant. In yet another embodiment of the invention, the aqueous dispersion of the aqueous coating composition optionally includes C-11 ketone. In still yet another embodiment of the invention, the aqueous dispersion of the aqueous coating composition optionally includes a surfactant.

In a twelfth embodiment of the invention, the invention is directed to a dispersant system comprising a carboxyalkyl cellulose ester and/or a water dispersible polymer, and a fluorosurfactant, wherein the dispersant system is capable of dispersing a hydrophobic material. In another embodiment of the invention, the aqueous dispersion of the aqueous coating composition optionally includes C-11 ketone. In yet another embodiment of the invention, the aqueous dispersion of the aqueous coating composition optionally includes a surfactant.

A person of ordinary skill in the art will be routinely able to adjust the amounts of the various components of the dispersant system to achieve the desired final aqueous dispersion. Exemplary amounts of the various components are as follows.

In one embodiment, the concentration of the carboxyalkyl cellulose ester in the aqueous dispersion ranges from about 0 to about 30%. In another embodiment, the concentration of the carboxyalkyl cellulose ester in the aqueous dispersion ranges from about 0.1% to about 20%. In yet another embodiment, the concentration of the carboxyalkyl cellulose ester in the aqueous dispersion ranges from about 0.4% to about 8%.

In one embodiment, the concentration of the water dispersible resin in the aqueous dispersion ranges from about 0 to about 60%. In another embodiment, the concentration of the water dispersible resin in the aqueous dispersion range from about 0 to about 30%. In yet another embodiment, the concentration of the water dispersible resin in the aqueous dispersion ranges from about 1% to about 10%.

In one embodiment, the concentration of the fluorosurfactant in the aqueous dispersion ranges from about 0 to about 30%. In another embodiment, the concentration of the fluorosurfactant in the aqueous dispersion ranges from about 0 to about 20%. In yet another embodiment, the concentration of the fluorosurfactant ranges from about 0-to about 6%.

Optionally, the aqueous dispersion contains C-11 ketone and/or surfactant. In one embodiment, the concentration of C-11 ketone in the aqueous dispersion ranges from about 0 to about 30%. In another embodiment, the concentration of C-11 ketone in the aqueous dispersion ranges from about 0 to about 12%. In yet another embodiment, the concentration of C-11 ketone in the aqueous dispersion ranges from about 0 to about 6%. In one embodiment, the concentration of surfactant in the aqueous dispersion ranges from about 0 to about 10%. In another embodiment, the concentration of surfactant in the aqueous dispersion ranges from about 0 to about 5%. In yet another embodiment, the concentration of surfactant in the aqueous dispersion ranges from about 0 to about 2%.

The balance of the particular composition consists of the hydrophobic material, solvents, including water, and miscellaneous additives such as stabilizers and/or rheology modifiers that will be readily apparent to those of ordinary skill in the art.

The following examples are illustrative, but not limiting, of the methods of the present invention. Other suitable modifications and adaptations of the variety of conditions and parameters normally encountered in the field, and which are obvious to those skilled in the alt, are within the spirit and scope of the invention.

All patents and publications cited herein are fully incorporated by reference herein in their entirety.

### EXAMPLES

### Example 1

### Preparation of a Carboxyalkyl Cellulose Ester Solution

Example 1. CMCAB 641.2 Solution Development

| Item | Wt/grams |
|---|---|
| 2-butoxyethanol | 210.89 |
| DI water | 28.38 |
| CMCAB 641.2 (WG0029) | 60.73 |

Sample is rolled on roller mill or mixed with a dissolver until solution is obtained.

### Examples 2-5

### Preparation of Hydrophobic Aqueous Dispersions Utilizing a Carboxyalkyl Cellulose Ester and a Fluorosurfactant

Examples 2-5. Aqueous Dispersions Varying the Level of Polyoxetane Fluorosurfactant

| | Formulation, Wt/grams | | | |
|---|---|---|---|---|
| Item | Example 2 | Example 3 | Example 4 | Example 5 |
| Example 1 | 42.39 | 42.39 | 42.39 | 42.39 |
| C-11 ketone (Kesolv | 4.78 | 4.78 | 9.97 | 9.97 |
| 184) | | | | |
| Triethanol amine | 1.51 | 1.51 | 1.51 | 1.51 |
| PolyFox PF-151N | 29.8 | 14.90 | 7.45 | 3.72 |
| Flexipel S22WS | 14.90 | 29.80 | 37.25 | 40.98 |

Mix well, then add very slowly with excellent agitation

| | | | | |
|---|---|---|---|---|
| DI Water | 113.75 | 113.75 | 113.75 | 113.75 |
| B20P126G defoamer | | 3.13 | | |
| TOTAL | 207.13 | 210.26 | 212.32 | 212.32 |
| Comments | Product has | Defoamer did | The addition of | Product really |
| | fine foam, but | not make much | water really | smooths out |
| | looks | difference in | seems to | once water is |
| | incredibly | foam; product | smooth the | added. Product |
| | smooth. | looks very | product out. | looks smooth; |
| | Product goes | interesting. | Again, product | allow to |
| | on to develop a | After | looks very | deareate 2-3 |
| | foam head. A | deareation, 1.5 mil | smooth; after | hours, then |
| | 1.5 mil draw | drawdown | dearation | make 1.5 mil |
| | down forms a | results in a | several hours, | drawdown on |
| | smooth film | smooth hazy | 1.5 mil dd | Form 7B. |
| | that beads | film; product | results in a | Smooth, hazy |
| | water initially, | beads water | smooth, hazy | film results. |
| | then water | well initially, | film that beads | Place DD into |
| | spreads | then the water | water readily, | 80 C oven for |
| | | droplet spreads | but then water | 22 min, cool |
| | | | spreads | 1 hr. Water |
| | | | | beads with a |
| | | | | very |
| | | | | significant |
| | | | | contact angle |
| | | | | >1 hr. |

Example 5 may be used as is or reduced with water under agitation to make baths as shown below in Examples 8 and 9 to impart water and oil repellency to substrates.

### Example 6

### Evaluation of Water Repellency Utilizing the Aqueous Dispersion

A bath of the Example 2 dispersion was prepared by placing 68.83 grams of Example 2 dispersion into a 600 ml beaker. The mixture was stirred and then 79.38 grams of deionized water was added. The mixture was again stirred. The mixture had a creamy foam on the surface that was removed. The balance of the sample looked good.

4.95 grams of 100% cotton was dipped into the bath and squeezed by hand. The resultant wet cotton weighed 12.50 grams. The wet cotton was cured at 80° C. for 15 minutes. After a 2 hour recovery period, a water drop was placed on the treated cotton. Initial wicking of the water took place within 10 seconds, with complete wick occurring after about 6 minutes for one drop.

6.13 grams Repearl MF crosslinker was added to the remainder of the bath. After stirring, a piece of cotton weighing 4.87 grams was dipped into the bath and squeezed. The resultant wet cotton weighed 12.68 grams. The wet cotton was cured at 132° C. for 20 minutes. After a 2 hour recovery period, a drop of water was place on the cured cotton. Initial wicking of the water took place after 3 minutes 10 seconds, while a final wicking took place after 4 minutes.

### Example 7

### Preparation of Aqueous Dispersion Utilizing Carboxyalkyl Cellulose Ester and Reduced Levels of Fluorosurfactant

Example 7. Dispersion of Perfluorinated Acrylic Polymer
with Reduced Levels of PF-151N

| Item | Wt/grams |
|---|---|
| Example 1 | 42.89 |
| C-11 ketone (Kesolv 184) | 9.97 |
| Triethanol amine | 1.52 |

Add the following slowly under excellent agitation

| | |
|---|---|
| PolyFox PF-151N | 1.86 |
| Flexipel S22WS | 42.84 |

Mix well, then add very slowly with excellent agitation

| | |
|---|---|
| DI Water | 113.75 |
| TOTAL | 212.33 |

Comments:
Seems smooth; allow to deareate overnight;
Made 1.5 mil DD, form 7B - Initial DD cratery, but non cratered part
appears smooth, and sample seems to smooth out a little as it flashes.
Air dry approx. 1 hr 50 min, 20 min @80 C, cool for 2 hours. Product
maintains excellent water beading for >2 hrs.

Example 7 may be used as is or reduced with water under agitation to make baths as shown below in Examples 8 and 9 to impart water and oil repellency to substrates.

### Examples 8 and 9

### Baths Utilizing the Aqueous Dispersions of Examples 5 and 7

Comparative Examples 8 and 9

| | Bath, Wt/grams | |
|---|---|---|
| Item | Example 8 | Example 9 |
| Example 5 | 100 | |
| Example 7 | | 100 |

Add the following slowly under agitation

| DI water | 129 | 123 |
|---|---|---|
| Bath appearance | Looks smooth | Looks smooth |
| Fabric label | Example 8A | Example 9A |
| Wt 100% cotton | 5.18 | 4.70 |
| (approx. 9 in × 8 in) | | |
| Wt cotton plus bath | 13.48 | 12.26 |
| Cure 30 min at 80 C. | | |
| Wt cotton out oven and | 5.51 | 4.90 |
| 5 min cool | | |
| Water bead after | >10 hours, no initial | >10 hours, no initial |
| weekend | wicking | wicking |
| Olive oil holdout | >60 hours | |

### Examples 10-13

### Comparison of Aqueous Dispersions of Carboxyalkyl Cellulose Esters in Combination with a Fluorosurfactant with Aqueous Dispersions Comprising Only Carboxyalkyl Cellulose Esters

Comparative Examples 10-13

| | Example 10 | Example 11 | Example 12 | Example 13 |
|---|---|---|---|---|
| Item | Wt/% | | | |
| Ethylene glycol | 34.82 | 23.21 | 20.16 | 19.61 |
| monobutyl ether | | | | |
| DuPont DBE | 4.12 | 2.75 | 19.25 | 18.72 |
| Dibasic Esters | | | | |
| CMCAB 641.2 | 14.92 | 9.98 | 9.17 | 7.13 |

Mix until dissolved

| | | | | |
|---|---|---|---|---|
| AMP-95 | 1.65 | 1.1 | 1.01 | 0.78 |
| Flexipel S-22 WS | 7.41 | 4.94 | 9.17 | 8.91 |

Mix well, then add the following under excellent agitation

| | | | | |
|---|---|---|---|---|
| DI Water | 37.07 | 58.05 | 41.24 | 44.85 |
| Appearance | Hazy yellowish | Hazy, foamy | Off-white viscous | Hazy liquid, |
| | liquid | | liquid | looks good |
| 1.5 mil DD, flash | Uniform, but | Uniform, but | Uniform, less | Uniform, fine |
| and heat at 132 C. | grainy | grainy | grainy | grain film |
| for 10 min | | | | |
| Stability | | | Very slow oil | Some |
| | | | separation | separation |
| | | | initially, but | |
| | | | further evaluation | |
| | | | showed | |
| | | | significant | |
| | | | separation | |

Example 12 was further evaluated by Hamby Textile Research Laboratory (Raleigh, N.C.) by pad application. The results of the study showed a 0 rating for oil and water repellency (i.e., no repellency).

### Examples 14 and 15

### Baths Utilizing the Aqueous Dispersions of Examples 12 and 13

Comparative Examples 14 and 15

| | Bath, Wt/grams | |
|---|---|---|
| Item | Example 14 | Example 15 |
| Example 12 | 10 | |
| Example 13 | | 5 |

Add the following slowly under agitation

| DI water | 100 | 95 |
|---|---|---|
| Bath appearance | Some floatation | Uniform, little foam |
| | after 30 min | |
| Fabric label | Example 14A | Example 15A |
| Wt 100% cotton | 6.85 | 6.46 |
| (approx. 80 cm × 80 cm) | | |
| Wt cotton plus bath | 15.89 | 15.09 |
| Cure 10 min at 132 C. | | |
| Wt cotton out oven | 6.82 | 6.46 |
| Water penetration | Approx. >30 min | Immediate wicking, |
| | | with complete |
| | | disappearance in 13 min |
| Olive oil holdout | Approx. >5 min | |

### Examples 16-19

### Comparison of Aqueous Dispersions of Carboxyalkyl Cellulose Esters in Combination with a Fluorosurfactant with Aqueous Dispersions Comprising Only Carboxyalkyl Cellulose Esters

Comparative Examples 16-19

| | Example 16 | Example 17 | Example 18 | Example 19 |
|---|---|---|---|---|
| Item | Wt/grams | | | |
| Methyl n-amyl | | 8.86 | 10.91 | |
| ketone | | | | |
| Methyl propyl | | 8.92 | | |
| ketone | | | | |
| Kesolv 184 | | 2.00 | | 4.78 |
| Irganox 1010 | | 0.4 | | |
| Ethylene | 42.27 | | 34.10 | |
| glycol | | | | |
| monobutyl | | | | |
| ether | | | | |
| CMCAB | 18.11 | 8 | 14.61 | |
| 641.2 | | | | |
| Example 1 | | | | 42.39 |

Mix until dissolved

| | | | | |
|---|---|---|---|---|
| AMP-95 | 1.00 | | | |
| PolyFox PF- | | | 20.00 | 14.90 |
| 3320 | | | | |
| Flexipel S-22 | 9.05 | 49.78 | 19.86 | 14.90 |
| WS | | | | |
| PolyFox PF- | | 0.24 | | |
| 6520 | | | | |
| Triethanol- | | | 2.00 | 1.51 |
| amine | | | | |
| AMP-95 | | 0.88 | | |

Mix well, then add the following slowly under excellent agitation

| | | | | |
|---|---|---|---|---|
| DI water | 55.62 | 190.47 | 130 | 113.75 |
| Appearance | Hazy, nearly | Extremely | Looks good | Pretty |
| | clear viscous | foamy, will | initially, but | smooth |
| | liquid | not filter 50 | after 7 days | product |
| | | micron or | shows some | results with |
| | | silk | kick out and | essentially |
| | | | phase | no air |
| | | | separation | |
| Dispersibility | Quickly | | | |
| at 5% | dispersed, | | | |
| concentration | foaming | | | |
| | emulsion | | | |
| Let down | Some | | | |
| appearance | separation on | | | |
| | top, settling | | | |
| | on bottom | | | |
| 1.5 mil DD | Continuous, | | | |
| appearance | very rough, | | | |
| | glossy | | | |
| 3mil DD | | Foamy/ | Very grainy | Product dries |
| appearance | | seedy, hazy, | and greasy | to be quite |
| | | grainy | with | seedy and |
| | | film results | excellent | blue in color |
| | | | gloss | |
| Water bead | | Beads water | Does not | |
| | | very well | bead water, | |
| | | | but rather | |
| | | | splits the | |
| | | | water into an | |
| | | | incomplete | |
| | | | circle | |
| Other | | Sample | Product goes | |
| comments | | shows lots of | on to show | |
| | | stuff floating | significant | |
| | | on top | separation - | |
| | | | 3 phases | |

Examples 10-19, above, illustrate the difficulty in making a uniform, stable dispersion that produces a grit free film and that can be further reduced with water to provide improved water and oil repellency to various substrates utilizing aqueous dispersions of only carboxyalkyl cellulose esters.

Thus, it has been found that the combination of carboxyalkyl cellulose ester, such as carboxymethyl cellulose acetate butyrate, in combination with a fluorosurfactant, such as the polyoxetane fluorosurfactant PolyFox PF-151N, provides a method of easily dispersing very hydrophobic materials, such as perfluorinated acrylic polymers, to produce stable, uniform dispersions that produce grit free films.

The aqueous dispersion containing carboxyalkyl cellulose esters and fluorosurfactant may be further reduced with water and coated onto a substrate, such as 100% cotton, to provide coated substrates with outstanding water and oil repellency.

Further, it has been found that decreased dispersion particle size, improved dispersion stability, and improved dispersion drawdown appearance may be obtained utilizing carboxyalkyl cellulose esters, such as carboxymethyl cellulose acetate butyrate, a polyoxetane fluorosurfactant, such as PolyFox PF-151N, and a C-11 ketone (Kesolv 184), when dispersing particularly difficult items such as a mineral spirits solution of perfluorinated acrylic polymer, particularly when the batch sizes are increased.

### Examples 20-23

### Comparison of Aqueous Dispersions of Carboxyalkyl Cellulose Esters in Combination with a Fluorosurfactant and C-11 Ketone with Aqueous Dispersions Comprising Carboxyalkyl Cellulose Esters, a Fluorosurfactant, and Ethylene Glycol Monobutyl Ether

Comparative Examples 20-23. PolyFox PF-151N Level and Solvent Type on
Dispersion of Perfluorinated Acrylic Polymer at Larger Batch Size

| | Example 20 | Example 21 | Example 22 | Example 23 |
|---|---|---|---|---|
| Item | Wt/grams | | | |
| Example 1 | 42.39 | 84.78 | 84.78 | 84.78 |
| Ethylene glycol | 9.97 | | | |
| monobutyl ether | | | | |
| C-11 Ketone | | 19.94 | 19.94 | 19.94 |
| (Kesolv 184) | | | | |
| Triethanol amine | 1.51 | 3.02 | 3.02 | 3.02 |
| PolyFox PF- | 3.72 | 7.44 | 3.72 | |
| 151N | | | | |
| Flexipel S-22WS | 40.98 | 81.96 | 85.68 | 89.40 |

Mix well, then add the following very slowly with excellent agitation

| | | | | |
|---|---|---|---|---|
| DI water | 113.75 | 227.50 | 227.50 | 227.50 |
| Comments | Product seems | Product is quite | Product is quite | Product is quite |
| | to go together | foamy, but | foamy, but | foamy, but |
| | relatively OK, | foam is smooth, | foam is smooth, | foam is smooth, |
| | some what | not grainy | not grainy | not grainy |
| | grainy | | | |
| | appearance | | | |
| | After | After | After | After |
| | overnight, | overnight, | overnight, | overnight, |
| | sample shows | sample shows a | sample shows a | sample shows a |
| | mod macro | fairly large | fairly large | rather large |
| | foam head and | macrofoam | macrofoam | head of |
| | mod layer | layer; there | layer; there | macrofoam |
| | separation | appears to be a | appears to be a | layer. |
| | | clear meniscus | clear meniscus | |
| | | and the rest of | and the rest of | |
| | | the sample is | the sample is | |
| | | white | white | |
| | | indicating an | indicating an | |
| | | emulsion/ | emulsion/ | |
| | | dispersion | dispersion | |
| | Hand stirring | | | |
| | looks uniform, | | | |
| | except sample | | | |
| | looks two | | | |
| | phased on sides | | | |
| | Significant | Does not | Does not | Sample shows |
| | separation after | separate after 4 | separate after 4 | significant |
| | 4 days | days | days | syneresis/ |
| | | | | separation after |
| | | | | several days; |
| | | | | the product |
| | | | | seems to stir |
| | | | | back in OK |

Examples 20-23 were further evaluated by making a 1.5 mil draw down with a bird bar and by evaluation of dispersion particle size under the microscope. The following table details the draw down results.

Examples 20-23. Draw Down Results

| | |
|---|---|
| Example 20 | After stirring back together, the draw down is |
| | very clear with what appears to be air bubbles |
| | present. The sample goes on to dry to a very |
| | hazy, grainy (fine grained) mud cracked film |
| Example 21 | Initially draw down is quite smooth, relatively |
| | clear. Draw down goes on to dry to a |
| | somewhat hazy but very smooth film |
| Example 22 | Product craters initially, then smooths, except 1 |
| | crater; product is slight more white than |
| | Example 21. |
| Example 23 | Product seems lower viscosity (larger particle |
| | size?). Sample initially has lots of craters and |
| | dimples. Drawn down film is also more white |
| | in appearance than Examples 21 and 22. |
| | Product dries with lots of craters. |

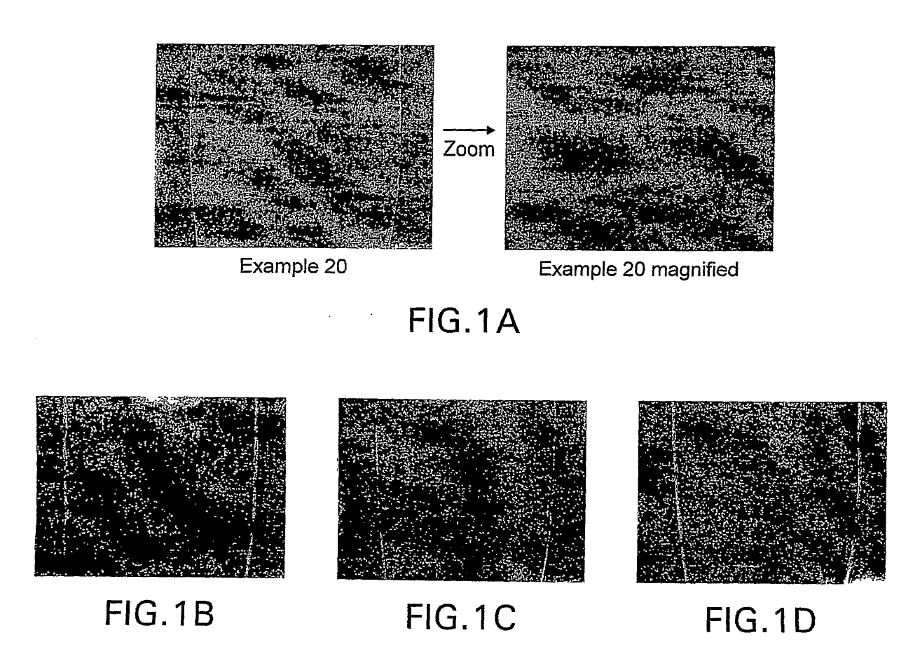

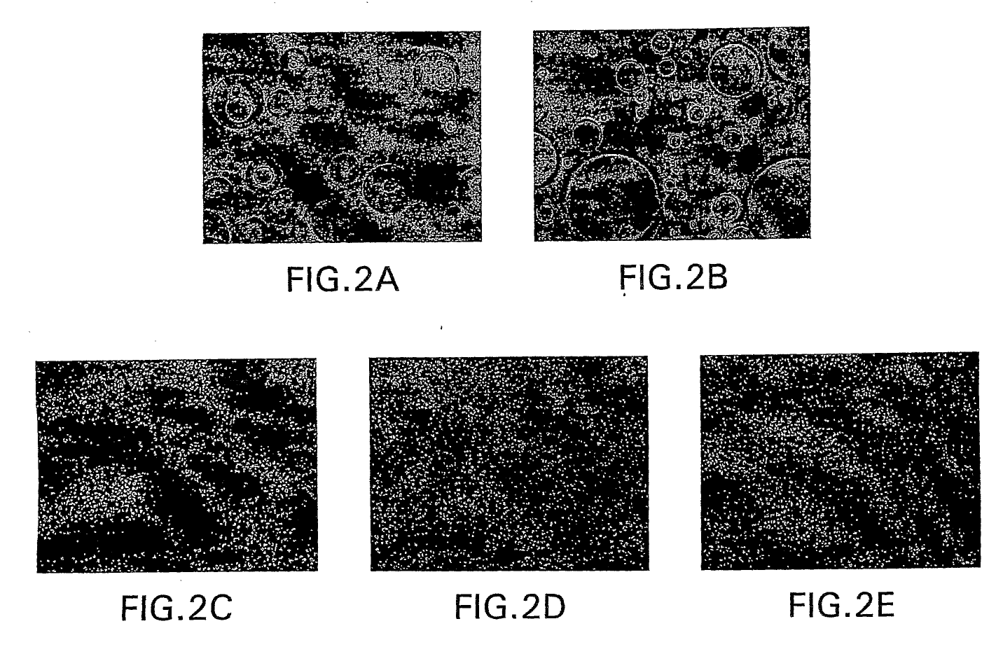

FIGS. 1 and 2 show the draw down appearances of the samples discussed above and images showing particle size/size distribution, given by the combination of carboxymethyl cellulose acetate butyrate, PolyFox PF-151N, and C-11 ketone in the dispersion of perfluorinated acrylic polymer in mineral spirits.

### Examples 24 and 25

### Comparison of Aqueous Dispersions of Carboxyalkyl Cellulose Esters in Combination with a Fluorosurfactant and C-11 Ketone with Aqueous Dispersions Comprising Carboxyalkyl Cellulose Esters and a C-11 Ketone

Examples 24 and 25. Comparison of Dispersions of CMCAB/PF151N
and CMCAB

| | Example 24 | Example 25 |
|---|---|---|
| Item | Wt/grams | |
| Example 1 | 42.39 | 46.11 |
| C-11 ketone (Kesolv | 9.97 | 9.98 |
| 184) | | |
| Triethanolamine | 1.53 | 1.55 |
| (TEOA) | | |
| PolyFox PF-151N | 3.75 | |

Add the following under excellent agitation

| | | |
|---|---|---|
| Flexipel S-22 WS | 40.98 | 40.98 |

Mix well, then add very slowly with excellent agitation

| | | |
|---|---|---|
| DI Water | 113.75 | 113.75 |
| Initial comments | Uniform dispersion; | Uniform, smooth, white, |
| | semi-thick, white, | semi-thick |
| | smooth | |
| 1.5 mil draw down | Smooth, semi-foamy, | Whitish appearance film |
| appearance (wet) | whitish appearance film | with lots of small |
| | | craters, orange peel look |
| Comments after | Sample is rather high in | Sample is rather high |
| ageing approx. 3 | viscosity and white; | viscosity and white - |
| mos | sample has a clear | sample seems to have a |
| | meniscus present. | clear meniscus present. |
| | Insertion of spatula | Insertion of spatula |
| | shows that this clear | reveals that there is def |
| | meniscus is a syneresis | slight syneresis present, |
| | layer - sample seems to | but def. significantly |
| | stir together OK | less than Example 24 |

### Examples 26 and 27

### 4% Baths Utilizing the Aqueous Dispersions of Examples 24 and 25

Examples 26 and 27. Displaying Baths Made From Examples 24 and 25
Dispersions

| | Example 26 | Example 27 |
|---|---|---|
| Item | Wt/grams | |
| Example 24 | 101.53 | |
| Example 25 | | 111.55 |

Add under agitation with stir bar

| | | |
|---|---|---|
| DI Water | 136.05 | 92.38 |
| Initial appearance | Looks smooth with | Looks good, no foam, |
| | foamy surface | smooth |
| Bath appearance after | 3 layers present - | 2 layers present |
| sitting for about 3 | a rather large creamy | A creamy white top |
| months | white layer on top; a | layer; a rather large |
| | middle whitish layer; a | bottom layer that's |
| | small more clear bottom | whitish; product stirs |
| | layer; product seems to | back OK, but def |
| | stir back together | seeding - seemingly |
| | relatively OK, but some | more than Example 26 |
| | apparent seeding present | |

### Examples 28 and 29

### Cloths Treated with the Baths of Examples 26 and 27

Examples 28 and 29. Displaying 100% Cotton Cloths Treated With
Examples 26 and 27 and Their Resulting Properties

| | Example 28 | Example 29 |
|---|---|---|
| | Bath Reference | |
| | Example 26 | Example 27 |
| | Fabric Label | |
| | Example 28A | Example 29A |
| Wt. 100% Cotton | 3.43 g | 3.53 g |
| Wt. 100% cotton & bath | 8.50 g | 9.22 g |
| Cure 30 min @80 C. | | |
| Wt. fabric out of oven | 3.64 g | 3.74 g |
| after 5 min cool | | |

Water and Olive oil holdout results

| | | |
|---|---|---|
| 1 drop Di-H₂O | H₂O evaporated after | 2 hr 59 min H₂O starts |
| | 4 hrs | to soak in but |
| | | evaporated after |
| | | 4 hrs |
| 1 drop Olive oil | Still present after long | Began to soak in after |
| | weekend (>48 hrs) | 30 min |
| 2 ml Di-H₂O | H₂O evaporated after | H₂O evaporated after |
| | 24 hrs 9 min | 24 hrs 33 min |
| 2 ml Olive oil | Complete failure after | Complete failure after |
| | 9 days | 2 hrs 7 min |

### Example 30

### Carboxymethyl Cellulose Acetate Butyrate Solution

Example 30. CMCAB 641.2 Solution Intermediate

| Item | Wt/grams |
|---|---|
| N-butanol | 782.10 |
| DI water | 105.30 |
| CMCAB 641.2 | 112.60 |

Mix until dissolved

### Examples 31 and 32

### Tire Dressing Materials Prepared from an Aqueous Dispersion Containing a Carboxyalkyl Acetate Ester and a Fluorosurfactant

Examples 31 and 32. Examples of Novel Tire Dressing Materials Made From the
Novel Dispersant Combination of CMCAB 641.2 and PolyFox PF-151N

| | Example 31 | Example 32 |
|---|---|---|
| Item | Wt/grams | |
| Astrocure 78 | 13.07 | 13.07 |
| Example 30 | 117.31 | |
| Example 1 | | 65.27 |
| Ethylene glycol monobutyl | | 81.98 |
| ether | | |
| DuPont DBE Dibasic Esters | 29.91 | |
| Irganox 1010 | 0.89 | 0.89 |

Mix until dissolved, then add

| | | |
|---|---|---|
| BYK 348 | 94.01 | 94.01 |

Mix, then add

| | | |
|---|---|---|
| Triethanolamine | 2.25 | 2.25 |
| PolyFox PF-151N | 6.54 | 6.54 |
| B20P126G silicone defoamer | 0.91 | 0.91 |

Mix, then add with excellent agitation

| | | |
|---|---|---|
| Tap water | 480.98 | 480.98 |

Mix then add

| | | |
|---|---|---|
| Dynol 604 | 2.21 | 2.21 |
| BYK 333 | 2.10 | 2.10 |
| Filter 50 micron | Yes | Yes |
| Spray leneta chart | Sprays pretty well, some | Sprays well |
| | large air that breaks readily | |
| Flow | Initial flow looks good - | Initial flow looks great |
| | final flow is not great, but | |
| | glossy | |
| Application to tires | Glossy finish, looks good | Glossy smooth finish. |
| | | Drove 600 miles with tires |
| | | looking great at end |
| | | (exposed to mountains, |
| | | rain, and sun) |
| Oven stability (49 C.) | Sample separates into two | Sample does not separate |
| | phases with slight | after 7 days; sample has |
| | settlement on bottom; | only very slight settling on |
| | sample shows cratering in | bottom and sample does |
| | jar, and is quite white; | not crater on inside of jar |
| | Sample shakes together | |
| | quite easily | |

BYK 348 is a Polyether modified poly-dimethyl-siloxane available from BYK-Chemie, Wallingford, Conn.

### Example 33

### Tire Dressing Materials Prepared from an Aqueous Dispersion Containing a Carboxyalkyl Acetate Ester and a Fluorosurfactant

Example 33. Tire Dressing Formulation

| Item | Wt/grams |
|---|---|
| Roskydal 502BA | 16.38 |
| Example 1 | 65.39 |
| Ethylene Glycol Monobutyl ether | 81.95 |
| (EB) | |
| 4-Methoxyphenol, 99% (MEHQ) | 0.51 |

Mix well, then add

| | |
|---|---|
| BYK 348 | 94.01 |
| Triethanol amine (TEOA) | 2.25 |
| PolyFox PF-151N | 6.54 |
| B7P88B defoamer | 0.91 |

Mix well, then add the following under excellent agitation

| | |
|---|---|
| Tap Water | 480.98 |

Mix and add

| | |
|---|---|
| Dynol 604 | 2.21 |
| BYX 333 | 2.10 |

Off white emulsion/dispersion results
Filter 50 micron
Sample was applied to tires and exposed to approx. 636 miles with
resulting good appearance of tires
Liquid sample was exposed to 14 days oven stability test at 49° C.
with slight settlement occurring, that seemed to stir back in without
resulting in cratering

### Example 34

### Wheel Polish Material Prepared from an Aqueous Dispersion Containing a Carboxyalkyl Acetate Ester and a Fluorosurfactant

Example 34. Wheel Polish Formulation

| Item | Wt/grams |
|---|---|
| Example 1 | 28.26 |
| Ethylene Glycol Monobutyl ether | 35.50 |
| (EB) | |
| 4-Methoxyphenol, 99% (MEHQ) | 0.22 |

Mix well, then add

| | |
|---|---|
| BYK 348 | 46.41 |

Mix well then add

| | |
|---|---|
| Triethanol amine (TEOA) | 0.98 |
| PolyFox PF-151N | 2.87 |
| B7P88B defoamer | 0.40 |

Mix well, then add the following under excellent agitation

| | |
|---|---|
| Tap Water | 587.95 |

Mix and add

| | |
|---|---|
| Dynol 604 | 0.96 |
| BYK 333 | 0.91 |

Approx. clear soln results
Filter 50 micron
Sample was applied to wheels and exposed to approx. 636 miles
with resulting good appearance of wheels
Liquid sample was exposed to 14 days oven stability test at 49° C.
with very slight settlement occurring, that seemed to stir back in
without resulting in cratering - sample is very clear

### Example 35

### An Aqueous UV Formulation Utilizing TAW 10-3

An aqueous UV formulation was made with TAW 10-3. First, the amount of triethylamine (“TEA”) in TAW 10-3 as supplied was determined utilizing Calculation 1.

### Calculation 1:

$$\begin{matrix}amine ( g ) = ( Resin N V wt ) ( Resin Acid \# ) ( Amine Eq . Wt . ) \\ ( \% Neutralization ) ( 1.783 \times {10}^{- 7} ) \\ = ( 48 ) ( 48.5 ) ( 101 ) ( 85 ) ( 1.783 \times {10}^{- 7} ) \\ = 3.56 g ( note \text{:} formula from Eastman C M C A B brochure )\end{matrix}$$

The amount of TEA in TAW 10-3 as supplied may also be determined utilizing Calculation 2.

### Calculation 2:

$$\begin{matrix}\begin{matrix}\frac{56 , 100}{acid \#} = \frac{56 , 100}{48.5} \\ = 1156.701 ( Eq . Wt . of T A W 10 \text{-} 3 on solids ) \\ \frac{Eq . Wt .}{Resin Wt .} = \frac{1156.701}{0.48} \\ = 2409.794 ( Eq . Wt . of T A W 10 \text{-} 3 as recieved )\end{matrix} & \\ \begin{matrix}amine ( g ) = ( \frac{100}{Eq . Wt . as received} ) \\ ( Amine Eq . Wt . ) ( \frac{\% Neutralization}{100} ) \\ = ( \frac{100}{2409.794} ) ( 101 ) ( \frac{85}{100} ) \\ = 3.56 g\end{matrix} & \end{matrix}$$

Then, the composition of TAW 10-3 was adjusted as detailed in the table below.

Example 35. Cytec TAW 10-3 Composition Adjusted for TEA

| | |
|---|---|
| Per TAW 10-3 | |
| Datasheet | 2. Adjusted to 100 g |

| | |
|---|---|
| 1. Item | Weight (g) |

| | | |
|---|---|---|
| Resin | 48.00 | 46.35 |
| Water | 40.00 | 38.62 |
| PM Acetate | 12.00 | 11.59 |
| TEA | 3.56 | 3.44 |
| TOTAL | 103.56 | 100.00 |

The TAW 10-3 can be utilized to disperse a UV resin thus making an aqueous UV Resin Formula. A clear film is produced indicating compatibility in the system.

### Example 36

### An Aqueous UV Formulation Utilizing TAW 10-3 and Omitting Triethanolamine

An aqueous UV formulation was made with TAW 10-3. Since the TAW 10-3 is pre-neutralized with TEA, the triethanolamine (“TEOA”) was left out.

Example 36. Type Formulation with TAW 10-3

| Item | Weight (g) |
|---|---|
| Sartomer SR344 | 12.66 |
| TMPTA-N | 10.31 |
| 4-Methoxyphenol | 0.14 |
| Astrocure 85 | 65.85 |
| Cytec TAW 10-3 | 22.24 |
| PF-3320 | 0.28 |
| PF-151N | 2.56 |

Mix well until smooth and warm ≈15 min, heat 30 min @
60° C., mix 15 min, then scrape sides and bottom, then add the
following very slowly while mixing with excellent agitation

| | |
|---|---|
| DI Water | 85.95 |
| (a) TOTAL | 200.00 |
| % NVM | 50.42 |
| % VOC | 1.80 |

The sample separated into two phases with a clear liquid top and solid white bottom. The sample was remade trying three different approaches. First, the neutralization was decreased to 80% with the addition of TEOA and the solids were reduced to ≈45% by adding water and EB, while keeping the VOC at 3.5%. The second sample was made as the first, but PF151N was left out. In the third sample, the CMCAB Solution (see Example 43 below) replaced the EB added to the first approach raising the VOC to ≈4%. The amount of TEOA added was adjusted to compensate for the CMCAB acid equivalents.

The addition of the CMCAB solution to the UV resin utilizing the TAW 10-3 improves the appearance of the resin.

### Example 37

### Evaluation of the Dispersions of Example 36

To a portion of the dispersions of Example 36, photoinitiator, water, and additives were added to evaluate the samples for cure and appearance. A 20 RDS DD was made on Form N2A of each sample. The DDs were placed in the Low Relative Humidity Box ≈47° C. and 9% RH under air at 100 L/min and allowed to flash for 20 minutes. The DDs were then cured by 4 passes through the UV Curing Unit at 25-fpm, with a 300-WPI Hg lamp with an elliptical reflector.

The table below details these formulations and the results of the DDs.

Example 37. Formulations

| | Example 37A | Example 37B | Example 37C |
|---|---|---|---|
| Item | Weight (g) | | |
| Sartomer SR 244 | 12.66 | 12.66 | 12.66 |
| TMPTA-N | 10.31 | 10.31 | 10.31 |
| 4-Methoxyphenol | 0.14 | 0.14 | 0.14 |
| Cytec TAW 10-3 | 22.24 | 22.24 | 22.24 |
| Astrocure 85 | 65.85 | 65.85 | 65.85 |
| PF3320 | 0.28 | 0.28 | 0.28 |
| PF151N | 2.56 | — | 2.56 |
| Eastman EB | 1.15 | 1.15 | — |
| Example 43 | — | — | 3.50 |

Mix well until smooth and warm 15 min, heat 30 min @ 60° C.
mix 15 min, scrape sides and bottom of container, then add with agitation

| | | | |
|---|---|---|---|
| TEOA | 3.47 | 3.47 | 3.60 |

Mix well until smooth and warm, then add very slowly with excellent
agitation

| | | | |
|---|---|---|---|
| DI Water | 115.00 | 115.0 | 115.00 |
| TOTAL | 233.66 | 231.10 | 236.14 |
| % NVM | 43.15 | 43.08 | 43.12 |
| % VOC | 3.52 | 3.45 | 3.98 |
| pH/Temp | 7.62 @ 21.5° C. | 7.47 @ 23.0° C. | 7.20 @ |
| | | | 19.8° C. |
| Viscosity #2 Zahn | 14.34 s | 14.31 s | 16.75 s |
| Signature Cup | | | |

Evaluate cure and appearance

| | Example 37D | Example 37E | Example 37F |
|---|---|---|---|
| Item | Weight (g) | | |
| Example 37A | 50.00 | — | — |
| Example 37B | — | 50.00 | — |
| Example 37C | — | — | 50.00 |
| Irgacure 500 | 0.85 | 0.85 | 0.85 |

Mix 5 min with propeller blade then add

| | | | |
|---|---|---|---|
| DI Water | 7.24 | 6.97 | 7.50 |
| Dynol 604 | 0.64 | 0.64 | 0.64 |
| FS 85 | 0.78 | 0.78 | 0.78 |
| BYK 333 | 0.52 | 0.52 | 0.52 |
| TOTAL | 60.03 | 59.76 | 60.29 |
| 20 RDS DD | retracted from | retracted from | slight |
| Results | edges; clear but | edges, clear but | retraction, |
| | hazy around | hazy around | clear, |
| | retraction line, | retraction line, | subcraters, can |
| | can see slight | can see slight | see slight |
| | haze throughout | haze throughout | haze with light |
| | with lamp | with lamp, | |
| | | craters, orange | |
| | | peel | |

There was some separation in the dispersions of Example 37A and Example 37B, but they stirred back together easily. The dispersion of Example 37C did not separate.

The calculation to determine the amount of TEOA to add to reduce the neutralization to 80% is shown in Calculation 3 below.

### Calculation 3:

$$\# equivalents = \frac{resin wt}{equivalent wt}$$

$$For T A W 10 \text{-} 3 \text{:} \# equivalents = \frac{22.24}{2409.79} = 0.0092292$$

$$For Astrocure 85 \text{:} \# equivalents = \frac{65.85}{2244} = 0.0293449$$

$$TOTAL equivalents = 0.0385741$$

$$For T E A \text{:} \# equivalents = \frac{( 22.24 \times 0.0344 )}{101} = 0.0075748$$

$$Take 80 \% of total equivalents - 0.0385741 ( 0.80 ) = 0.0308593$$

$$Substract out T E A equivalents - 0.0308593 - 0.0075748 = 0.0232845$$

$$Multiply this by T E O A Eq . Wt . to get amount of T E O A to add g T E O A = 0.0232845 ( 149.19 ) = 3.47 g$$

### Example 38

### Evaluation of the Particle Size of Samples of Example 37

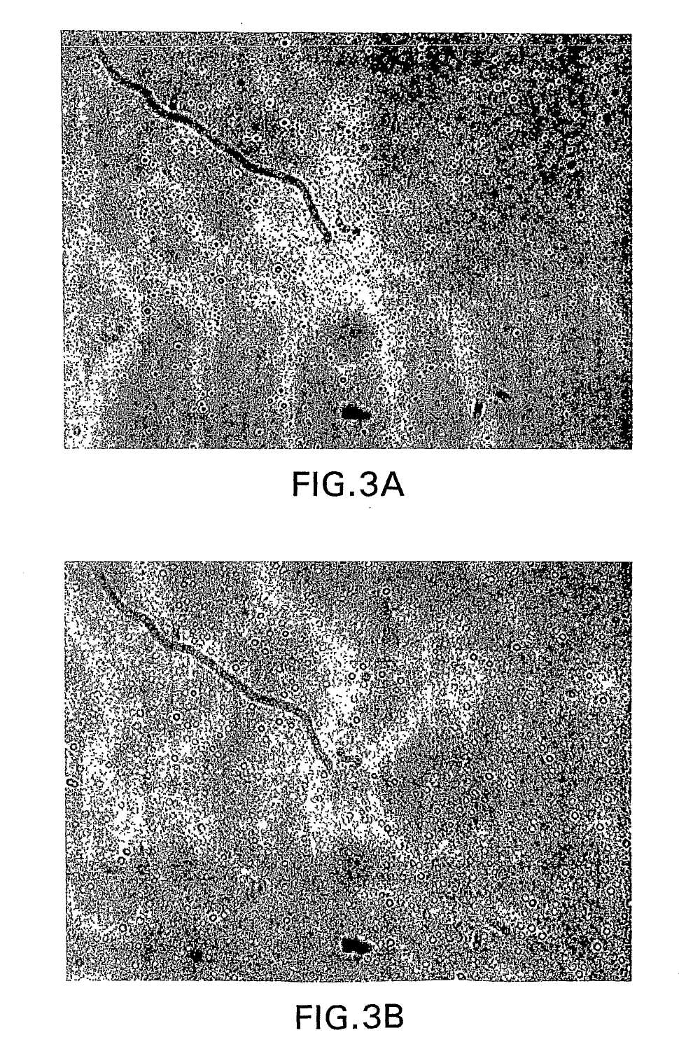

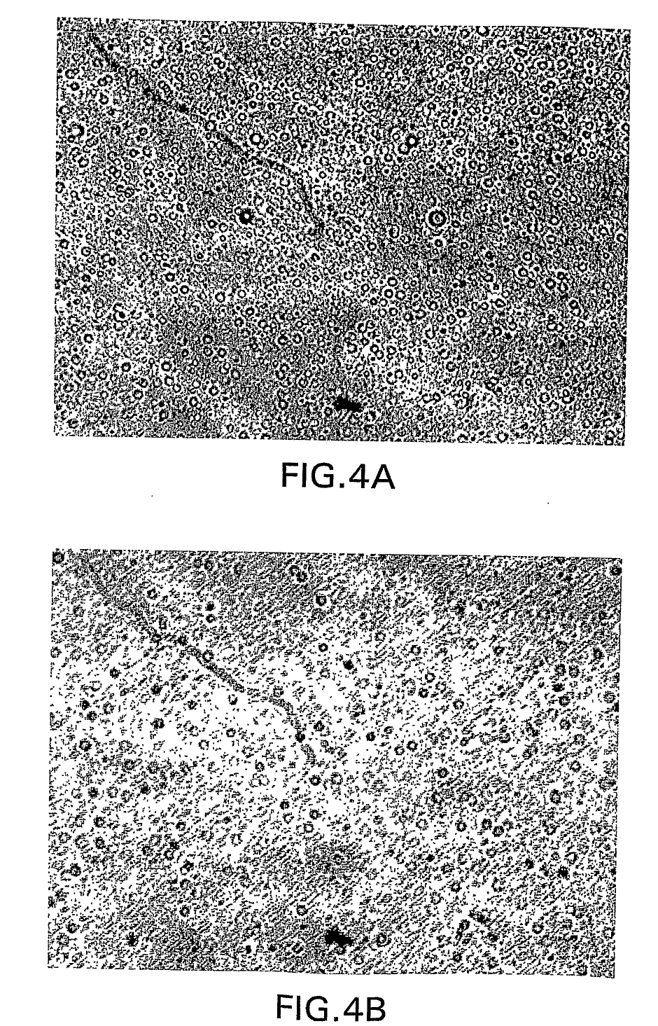

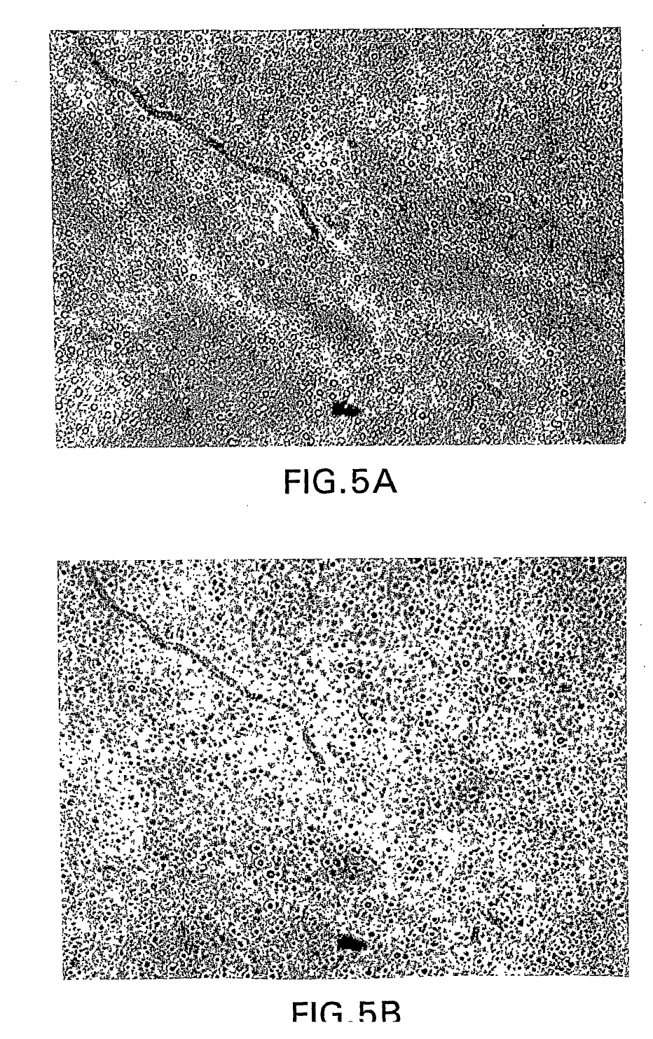

To evaluate the particle size of the dispersions of Example 37, the samples were cut 1/100 with DI water as detailed in the table below. These samples were then placed on a microscope slide and examined with transmitted light at 400× magnification. The images of the sample are shown as FIGS. 3-5.

Example 38. Samples for Evaluation of Particle Size

| | Example 38A | Example 38B | Example 38C |
|---|---|---|---|
| Item | Weight (g) | | |
| Example 37A | 0.11 | — | — |
| Example 37B | — | 0.10 | — |
| Example 37C | — | — | 0.10 |
| DI Water | 11.00 | 10.00 | 10.00 |
| TOTAL | 11.11 | 10.10 | 10.10 |

The addition of PolyFox PF-151N to the dispersion utilizing the TAW 10-3 and the CMCAB solutions results in decreased dispersion particle size.

### Example 39

### Compatibility Studies Utilizing Samples of Example 37

To the dispersion of Example 37F, Rhoplex CL-204 and Alberdingk AC-2538 were added 1:1 to determine compatibility. DDs were made and cured as stated above. The table below details the formulations and the results.

Example 39. Evaluation of the Addition of Latex to Dispersion of
Example 37F

| | |
|---|---|
| Example 39A | Example 39B |

| | |
|---|---|
| Item | Weight (g) |

| | | |
|---|---|---|
| Example 37F | 15.00 | 10.00 |
| Alberdingk AC-2538 | 15.00 | — |
| Rhoplex CL-204 | — | 10.00 |
| TOTAL | 30.00 | 20.00 |
| 20 RDS DD Results | Clear, cracked | Clear, cracked |

### Example 40

### Stability Studies Utilizing Samples of Example 37

The dispersion of Example 37C was placed in a 50° C. oven for 4 days to evaluate stability. The sample separated into two phases with a liquid top and semi-solid bottom. The sample was re-stirred and the pH and viscosity were measured. A 20 RDS DD was made as stated above. The table below details the results.

Example 40. Evaluation of Aged Dispersion of Example 37C

| Parameter | Results | % Change |
|---|---|---|
| pH/Temp | 6.03 @ 20.1° C. | −16.25 |
| Viscosity, Zahn #2 | 15.05 s | −10.15 |
| Signature Cup | | |
| 20 RDS DD | hazy, craters | |

Improvement in dispersion stability is required.

### Example 41

### Aqueous Acrylic Dispersions

Samples were made evaluating various polymers (see Table 1 below). The polymers with 100% NVM were dissolved in MAK to 60% solids and then added to the dispersion. The samples were then crosslinked with Bayhydur XP-7063, NCO:OH 1.1:1.0. A 3 mil DD on Leneta Form 7B was made of both the dispersion and the crosslinked sample. The DDs were air-dried overnight and then evaluated for cure and appearance. MEK double rubs were performed on the DDs of the crosslinked samples 10 days later. Tables 2-12 detail the formulations of the samples.

TABLE 1
Polymers Evaluated in the Formulation of Example 41EEE
(see Table 12 below)

| Polymer | Equivalent Weight | % NVM |
|---|---|---|
| Blown Castor Oil | 362 | 100 |
| Viscasil-60M (VISC- | no OH equivalents | 100 |
| 60M) | | |
| Industrial Castor Oil | 342 | 100 |
| PolyFox T | 1900 | 100 |
| Tego Airex 901W | no OH equivalents | 100 |
| SAA 100 | 267 | 100 |
| Tinuvin 328 | no OH equivalents | 100 |
| Paraloid B66 | no OH equivalents | 100 |
| Sartomer CN9101 | no OH equivalents | 100 |
| Acryflow P120 | 432 | 100 |
| BYK-Silclean 3700 | 1870 | 25 |
| Beckosol 12-035 | not available | 60 |
| Duramac 207-1205 | not available | 70 |
| Shamrock 395 N5 | no OH equivalents | 100 |

TABLE 2
Aqueous Acrylic Dispersions
Make 60% solutions

| | Example | Example | Example | Example | Example |
|---|---|---|---|---|---|
| | 41A | 41B | 41C | 41D | 41E |
| Item | Weight (g) | | | | |
| MAK | 12.00 | 12.00 | 12.00 | 12.00 | 12.00 |
| Blown Castor Oil | 18.00 | — | — | — | — |
| VISC 60M | — | 18.00 | — | — | — |
| Industrial Castor Oil | — | — | 18.00 | — | — |
| PolyFox T | — | — | — | 18.00 | — |
| Tego Airex 901W | — | — | — | — | 18.00 |
| TOTAL | 30.00 | 30.00 | 30.00 | 30.00 | 30.00 |

Add above samples to Dispersion formulation

| | Example | Example | Example | Example | Example |
|---|---|---|---|---|---|
| | 41F | 41G | 41H | 41I | 41J |
| Item | Weight (g) | | | | |
| Cytec TAW-10-3 | 23.65 | 23.65 | 23.65 | 23.65 | 23.65 |
| Example 41A | 23.82 | — | — | — | — |
| Example 41B | — | 23.82 | — | — | — |
| Example 41C | — | — | 23.82 | — | — |
| Example 41D | — | — | — | 23.82 | — |
| Example 41E | — | — | — | — | 23.82 |
| MAK | 1.43 | 1.43 | 1.43 | 1.43 | 1.43 |
| Santicizer 160 | 1.43 | 1.43 | 1.43 | 1.43 | 1.43 |

Add with excellent agitation

| | | | | | |
|---|---|---|---|---|---|
| UADDI Water | 24.08 | 24.08 | 24.08 | 24.08 | 24.08 |

Add slowly

| | | | | | |
|---|---|---|---|---|---|
| UADDI Water | 25.55 | 25.55 | 25.55 | 25.55 | 25.55 |
| TOTAL | 99.96 | 99.96 | 99.96 | 99.96 | 99.96 |
| pH/Temp | 7.90 @ | 8.32 @ | 8.20 @ | 8.16 @ | 8.28 @ |
| | 21.5° C. | 22.5° C. | 21.4° C. | 21.3° C. | 21.0° C. |
| Viscosity @ 78° F. #2 | 14.02 s | 14.40 s | 14.37 s | 14.20 s | 14.25 s |
| Zahn Signature Cup | | | | | |

Crosslink samples NCO/OH 1.1/1.0

| | Example | Example | Example | Example | Example |
|---|---|---|---|---|---|
| | 41K | 41L | 41M | 41N | 41O |
| Item | Weight (g) | | | | |
| Example 41F | 40.00 | — | — | — | — |
| Example 41G | — | 40.00 | — | — | — |
| Example 41H | — | — | 40.00 | — | — |
| Example 41I | — | — | — | 40.00 | — |
| Example 41J | — | — | — | — | 40.00 |
| Bayhydur XP-7063 | 6.51 | 2.25 | 6.76 | 3.06 | 2.25 |
| TOTAL | 46.51 | 42.25 | 46.76 | 43.06 | 42.25 |

(Note - UADDI Water refers to extra pure deionized water - standard deionized water may be used)

TABLE 3
Aqueous Acrylic Dispersions
Example 41P - 60% Castor Oil Solution

| Item | Weight (g) |
|---|---|
| MAK | 16.00 |
| Blown Castor Oil | 24.00 |
| TOTAL | 40.00 |

Add above sample to Formulation of Example 41F with the addition
of RM-825

| | |
|---|---|
| Example 41Q | Example 41R |

| | |
|---|---|
| Item | Weight (g) |

| | | |
|---|---|---|
| Cytec TAW 10-3 | 23.65 | 23.65 |
| Example 41P | 23.82 | 11.91 |
| MAK | 1.43 | 1.43 |
| Santicizer 160 | 1.43 | 1.43 |

Add with excellent agitation

| | | |
|---|---|---|
| UADDI Water | 24.08 | 24.08 |

Add slowly

| | | |
|---|---|---|
| UADDI Water | 25.55 | 25.55 |
| RM-825 | 0.80 | 0.70 |
| TOTAL | 100.76 | 88.75 |
| pH/Temp | 7.88 @ 21.8° C. | 8.07 @ 21.7° C. |
| Viscosity @ 78° F. #2 | 24.45 s | 16.07 s |
| Zahn Signature Cup | | |

Crosslink samples NCO/OH 1.1/1.0

| | Example | Example | Example | Example |
|---|---|---|---|---|
| | 41S | 41T | 41U | 41V |
| Item | Weight (g) | | | |
| Example 41Q | 30.00 | 30.00 | — | — |
| Example 41R | — | — | 30.00 | 30.00 |
| Bayhydur XP-7063 | 4.84 | — | 3.70 | — |
| Desmophen N-100 | — | 3.78 | — | 2.88 |
| TOTAL | 34.84 | 33.78 | 33.70 | 32.88 |

TABLE 4
Aqueous Acrylic Dispersions
Make 60% solutions

| | Example | Example | Example | Example |
|---|---|---|---|---|
| | 41W | 41X | 41Y | 41Z |
| Item | Weight (g) | | | |
| MAK | 12.00 | 12.00 | 12.00 | 12.00 |
| SAA 100 | 18.00 | — | — | — |
| Tinuvin 328 | — | 18.00 | — | — |
| Paraloid B66 | — | — | 18.00 | — |
| CN9101 | — | — | — | 18.00 |
| TOTAL | 30.00 | 30.00 | 30.00 | 30.00 |

Add above samples to Dispersion formulation

| | Example | Example | Example | Example |
|---|---|---|---|---|
| | 41AA | 41BB | 41CC | 41DD |
| Item | Weight (g) | | | |
| Cytec TAW 10-3 | 23.65 | 23.65 | 23.65 | 23.65 |
| Example 41W | 23.82 | — | — | — |
| Example 41X | — | 23.82 | — | — |
| Example 41Y | — | — | 23.82 | — |
| Example 41Z | — | — | — | 23.82 |
| MAK | 1.43 | 1.43 | 1.43 | 1.43 |
| Santicizer 160 | 1.43 | 1.43 | 1.43 | 1.43 |

Add with excellent agitation

| | | | | |
|---|---|---|---|---|
| UADDI Water | 24.08 | 24.08 | 24.08 | 24.08 |
| Add slowly | | | | |
| UADDI Water | 25.55 | 25.55 | 25.55 | 25.55 |
| RM-825 | 0.80 | 0.80 | 0.80 | 0.80 |
| TOTAL | 100.76 | 100.76 | 100.76 | 100.76 |
| pH/Temp | 8.09 @ | 8.42 @ | 8.23 @ | 8.45 @ |
| | 22.9° C. | 22.9° C. | 22.4° C. | 22.4° C. |
| Viscosity @ 78° F. | 63.21 s | Tinuvin | 20.31 s | 49.32 s |
| #2 Zahn Signature | | 328 did | | |
| Cup | | not | | |
| | | disperse | | |

Crosslink samples NCO/OH 1.1/1.0

| | Example | Example | Example | Example |
|---|---|---|---|---|
| | 41EE | 41FF | 41GG | 41HH |
| Item | Weight (g) | | | |
| Example 41AA | 40.00 | Did not | — | — |
| Example 41CC | — | make | 40.00 | — |
| Example 41DD | — | Tinuvin | — | 40.00 |
| Bayhydur XP-7063 | 7.96 | 328 did | 2.23 | 2.23 |
| TOTAL | 47.96 | not | 42.23 | 42.23 |
| | | disperse | | |

TABLE 5
Aqueous Acrylic Dispersions
Make 30% Tinuvin 328 and 60% Paraloid B66 solutions

| | |
|---|---|
| Example 41II | Example 41JJ |

| | |
|---|---|
| Item | Weight (g) |

| | | |
|---|---|---|
| Xylene | 28.00 | 16.00 |
| Tinuvin 328 | 12.00 | — |
| Paraloid B66 | — | 24.00 |
| TOTAL | 40.00 | 40.00 |

Add above samples to the formulation of Example 41EEE
(see Table 12 below)

| | |
|---|---|
| Example 41KK | Example 41LL |

| | |
|---|---|
| Item | Weight (g) |

| Cytec TAW 10-3 | 23.65 | 23.65 |
|---|---|---|
| Example 41II | 23.82 | — |
| Example 41JJ | — | 23.82 |
| MAK | 1.43 | 1.43 |
| Santicizer 160 | 1.43 | 1.43 |
| Add with excellent agitation | | |
| UADDI Water | 25.55 | 25.55 |
| RM-825 | 0.80 | 0.80 |
| TOTAL | 100.76 | 100.76 |
| pH/Temp | 8.03 @ 21.3° C. | 8.18 @ 22.3° C. |

Crosslink samples NCO/OH 1.1/1.0

| | |
|---|---|
| Example 41MM | Example 41NN |

| | |
|---|---|
| Item | Weight (g) |

| | | |
|---|---|---|
| Example 41KK | 40.00 | Did not make - B66 |
| Bayhydur XP-7063 | 2.23 | did not disperse |
| TOTAL | 42.23 | |

TABLE 6
60% Solutions in MAK

| | |
|---|---|
| Example 41OO | Example 41PP |

| | |
|---|---|
| Item | Weight (g) |

| | | |
|---|---|---|
| MAK | 16.00 | 16.00 |
| Acryflow P120 | 24.00 | — |
| Irgacure 819 | — | 24.00 |
| Comments | — | Mix, heat |
| | | 51° C. for 1 hr |
| TOTAL | 40.00 | 40.00 |

| | |
|---|---|
| Comments | Example 41PP - I819 not |
| | soluble; Xylene added to make |
| | 30% solution but still insoluble |

TABLE 7
Aqueous Acrylic Dispersions
Add above samples and other polymers to Formulation of
Example 41EEE (see Table 12 below)

| | Example 41QQ | Example 41RR | Example 41SS |
|---|---|---|---|
| Item | Weight (g) | | |
| Cytec TAW 10-3 | 23.65 | 23.65 | 23.65 |
| Example 41OO | 23.82 | — | — |
| BYK-Silclean 3700 | — | 23.82 | — |
| Beckosol 12-035 | — | — | 23.82 |
| MAK | 1.43 | 1.43 | 1.43 |
| Santicizer 160 | 1.43 | 1.43 | 1.43 |

Add with excellent agitation

| | | | |
|---|---|---|---|
| UADDI Water | 24.08 | 24.08 | 24.08 |
| Add slowly | | | |
| UADDI Water | 25.55 | 25.55 | 25.55 |
| RM-825 | 0.80 | 0.80 | 0.80 |
| TOTAL | 100.76 | 100.76 | 100.76 |
| pH/Temp | 8.07 @ | 8.12 @ | 7.48 @ 23.0° C. |
| | 21.9° C. | 21.4° C. | |
| Viscosity @ 78° F. | 24.03 s | 15.43 s | did not measure |
| #2 Zahn Signature | | | very foamy |
| Cup | | | |

Crosslink samples NCO/OH 1.1/1.0

| | Example 41TT | Example 41UU | Example 41VV |
|---|---|---|---|
| Item | Weight (g) | | |
| Example 41QQ | 40.00 | — | — |
| Example 41RR | — | 40.00 | — |
| Example 41SS | — | — | 40.00 |
| Bayhydur XP-7063 | 5.77 | 2.57 | 2.35 |
| TOTAL | 45.77 | 42.57 | 42.35 |

TABLE 8
Example 41WW - 60% Solution
Make 60% solution

| Item | Weight (g) |
|---|---|
| Duramac 207-1205 | 34.29 |
| MAK | 5.71 |
| TOTAL | 40.00 |

TABLE 9
Aqueous Acrylic Dispersions
Add above sample and Shamrock 395 N5 to Formulation of Example
41EEE (see Table 12 below)

| | |
|---|---|
| Example 41XX | Example 41YY |

| | |
|---|---|
| Item | Weight (g) |

| | | |
|---|---|---|
| Cytec TAW 10-3 | 23.65 | 23.65 |
| Example 41WW | 23.82 | — |
| Shamrock 395N5 | — | 23.82 |
| MAK | 1.43 | 1.43 |
| Santicizer 160 | 1.43 | 1.43 |
| UADDI Water | 24.08 | 24.08 |
| UADDI Water | 25.55 | 25.55 |
| RM-825 | 0.80 | — |
| TOTAL | 100.76 | 99.96 |
| pH/Temp | 7.86 @ 23.3° C. | 8.20 @ 22.0° C. |

Crosslink samples NCO/OH 1.1/1.0

| | |
|---|---|
| Example 41ZZ | Example 41AAA |

| | |
|---|---|
| Item | Weight (g) |

| | | |
|---|---|---|
| Example 41XX | 40.00 | — |
| Example 41YY | — | wax did not disperse |
| Bayhydur XP-7063 | 2.35 | — |
| TOTAL | 42.35 | — |

Example 41YY was remade adding Shamrock 395 N5 1:1 on TAW 10-3 solids as shown below in Table 10.

TABLE 10

| | |
|---|---|
| Item | Weight (g) |

Example 41BBB

| | |
|---|---|
| Cytec TAW 10-3 | 29.67 |
| Shamrock 395 N5 | 13.94 |
| MAK | 1.79 |
| Santicizer 160 | 1.79 |

Add with excellent agitation

| | |
|---|---|
| UADDI Water | 30.21 |
| UADDI Water | 32.05 |
| RM-825 | 0.88 |
| TOTAL | 110.33 |
| pH/Temp | 8.08 @ 23.3° C. |

Example 41CCC - Crosslink sample NCO/OH 1.1/1.0

| | |
|---|---|
| Example 41BBB | 40.00 |
| Bayhydur X-7063 | 2.56 |
| TOTAL | 42.56 |

A formulation of Example 41PP (see Table 6) was made, dissolving the Irgacure 819 in monomer and oligomer as shown below in Table 11.

TABLE 11
Example 41DDD

| Item | Weight (g) |
|---|---|
| TPGDA | 28.00 |
| Ebecryl 3700 | 12.00 |
| Irgacure 819 | 1.60 |

Mix, then heat in 66° C. oven 1 hr to dissolve Irgacure 819

| | |
|---|---|
| TOTAL | 41.60 |

This sample was dispersed in the formulation of Example 41EEE (see Table 12 below) and a sample with Cytec TAW 10-4 and a sample with a mixture of 65% methyl amyl ketone and 35% CAB 551.2 were also made. These formulas are detailed in Table 12. Example 41FFF was UV cured by 1 pass through the UV Curing Unit under a 300 WPI gallium lamp with a parabolic reflector at 352 mJ/cm².

TABLE 12
Example 41EEE

| | |
|---|---|
| Example 41FFF | Example 41GGG |

| | |
|---|---|
| Item | Weight (g) |

| | | |
|---|---|---|
| Cytec TAW 10-3 | 23.65 | — |
| Cytec TAW 10-4 | — | 23.65 |
| Example 41DDD | 14.29 | — |
| Mixture of 65% methyl | — | 23.82 |
| amyl ketone and 35% | | |
| CAB 551.2 | | |
| MAK | 1.43 | 1.43 |
| Santicizer 160 | 1.43 | 1.43 |

Add with excellent agitation

| | | |
|---|---|---|
| UADDI Water | 24.08 | 24.08 |
| Add slowly | | |
| UADDI Water | 25.55 | 25.55 |
| RM-825 | 0.72 | 0.80 |
| TOTAL | 91.15 | 100.76 |
| pH/Temp | 8.32 @ 23.7° C. | 8.02 @ 22.9° C. |

Crosslink samples NCO/OH 1.1/1.0

| | |
|---|---|
| Example 41HHH | Example 41III |

| | |
|---|---|
| Item | Weight (g) |

| | | |
|---|---|---|
| Example 41FFF | 40.00 | — |
| Example 41GGG | — | 40.00 |
| Bayhydur XP-7063 | 2.47 | 3.21 |
| TOTAL | 42.47 | 43.21 |

### Example 42

### Evaluation of the Aqueous Acrylic Dispersions of Example 41

The dispersion stability, dispersion DD, crosslinked DD, and MEK rubs for the aqueous acrylic dispersions of Example 41 are shown below in Table 13.

TABLE 13
Evaluation of Aqueous Acrylic Dispersions

| | | Dispersion | | | | |
|---|---|---|---|---|---|---|
| Sample | Polymer | Stability | Dispersion DD | Crosslinked Sample | Crosslinked DD | MEK Rubs |
| Example | 60% Blown Castor Oil | 24 hrs | clear, tacky, craters | Example 41K | hazy, tacky, craters | 91, lifted |
| 41F | in MAK | | | | | |
| Example | 60% VISC 60M in | 1 hr | did not form a film, | Example 41L | hazy, contracted, oily, | 21, lifted |
| 41G | MAK | | oily | | dewetting? | |
| Example | 60% Industrial Castor | 24 hrs | clear, tacky, craters | Example 41M | hazy, tacky, craters | 79, lifted |
| 41H | Oil in MAK | | | | | |
| Example | 60% PolyFox T in | 4 days | clear, contratced, | Example 41N | contracted, hazy, blue | 35, lifted |
| 41I | MAK | | tacky | | bloom, orange peel | |
| Example | 60% Tego Airex 901W | 2 days | clear, contracted, | Example 41O | craters, hazy, blue | 15 |
| 41J | in MAK | | craters, tackey | | bloom, orange peel | |
| Example | 60% Blown Castor Oil | 24 hrs | clear, tacky, craters | Example 41S | hazy, craters, tackey | 90, lifted |
| 41Q | in MAK | | | | | |
| Example | 60% Blown Castor Oil | 24 hrs | clear, tacky, craters | Example 41T | hazy, craters, tacky | 72, lifted |
| 41Q | in MAK | | | (w/Dismophen N- | | |
| | | | | 100) | | |
| Example | 60% Blown Castor Oil | 24 hrs | clear, tacky, craters, | Example 41U | hazy, craters, tacky | 64, lifted |
| 41R | in MAK (1/2 amount | | orange peel | | | |
| | of B13P282B) | | | | | |
| Example | 60% Blown Castor Oil | 24 hrs | clear, tacky, craters, | Example 41V | hazy, tacky | 32, lifted |
| 41R | in MAK (1/2 amount | | orange peel | (w/Desmophen N- | | |
| | of B13P282B) | | | 100) | | |
| Example | 60% SAA 100 in | 7 months+ | clear, dry, prints | Example 41EE | clear, dry, slight craters | 200+ |
| 41AA | MAK | | | | | |
| Example | 60% Tinuvin 328 in | insoluble in | white, powdery | Tinuvin 328 did not | | |
| 41BB | MAK | MAK | | dissolve | | |
| Example | 60% Paraloid B66 in | 24 hrs | hazy, gray, fritty | Example 41GG | hazy, gray, gritty | 20, lifted |
| 41CC | MAK | | | | | |
| Example | 60% CN9101 in MAK | 7 months+ | clear, tacky | Example 41HH | craters, tacky, cellular | 24, lifted |
| 41DD | | | | | pattern, not Benard | |
| | | | | | cells | |
| Example | 30% Tinuvin 328 in | ? jelled after | dry, blue bloom, | Example 41MM | dry, blue bloom, | 36, lifted |
| 41KK | Xylene | 7 months | powdery-resin | | powdery-resin kicked | |
| | | | kicked out | | out | |
| Example | 60% Paraloid B66 in | separated | gray, hazy, resin | resin not in | | |
| 41LL | Xylene | immediately | particles | | | |
| Example | 60% Acryflow P120 in | ? separated | clear, tacky | Example 41TT | tacky, hazy edges, clear | 68, lifted |
| 41QQ | MAK | after 7 | | | in center | |
| | | months | | | | |
| Example | BKY-Silclean 3700 | ? separated | slightly tacky, clear, | Example 41UU | clear, textured, dry, | 66, lifted |
| 41RR | | after 7 | textured, craters | | craters | |
| | | months | | | | |
| Example | Becksol 12-035 | ? separated | clear, tacky | Example 41VV | clear, dry, prints | 44, lifted |
| 41SS | | after 7 | | | | |
| | | months | | | | |
| Example | 60% Duramac 207- | ? separated | clear, tacky | Example 41ZZ | dry, clear, prints | 46, lifted |
| 41XX | 1205 | after 7 | | | | |
| | | months | | | | |
| Example | Shamrock 395 N5 | 1 hr | dry, white, waxy | wax not in | | |
| 41YY | | | | | | |
| Example | Shamrock 395 N5 (1:1 | 24 hrs | dry, hazy, prints, waxy | Example 41CCC | dry, hazy, waxy | 8 |
| 41BBB | TAW 10-3 on solids) | | | | | |
| Example | TPGDA/Ebecryl 3700/ | 2 weeks | airdry: tacky, clear | Example 41HHH | airdry: dry, clear, prints | 14, lifted |
| 41FFF | Irgacure 819 | | | | | |
| Example | TPGDA/Ebecryl 3700/ | 2 weeks | airdry overnight, then | Example 41HHH | airdry overnight, then | 200+ |
| 41FFF | Irgacure 819 | | UV Cure: sl. taacky, | | UV Cure: clear, dry, | |
| | | | clear | | craters | |
| Example | TPGDA/Ebecryl 3700 | 2 weeks | UV Cure then airdry | | | |
| 41FFF | (70/30) | | overnight: dry, hazy, | | | |
| | | | subcraters | | | |
| Example | B15P133B w/TAW | 2 weeks | hazy, dry | Example 41III | clear, dry | 66, lifted |
| 41GGG | 10-4 | | | | | |

The samples with SAA 100 (Example 41EE) and Irgacure 819 in TPGDA and Ebecryl 3700 (Example 41HHH) gave the best results in terms of giving a clear, dry film with excellent MEK Resistance. Overall, the SAA 100 dispersion (Example 41AA) was the best because it remained stable for over seven months whereas the Irgacure 819 dispersion (Example 41FFF) remained stable for only two weeks.

### Example 43

### Preparation of a Carboxyalkyl Cellulose Ester Solution

Example 43. CMCAB 641.2 Solution Development

| Item | Wt/grams |
|---|---|
| 2-butxyethanol | 314.08 |
| DI Water | 42.60 |
| CMCAB 641.2 | 143.70 |

mix until dissolved

### Example 44

### Dispersion of UV Oligomer to Make Aqueous UV Resin

Example 44. Sartomer CN2261 Dispersion

| Item | Wt/grams |
|---|---|
| Sartomer CN2261 | 187.41 |
| 4-Methoxyphenol | 0.14 |
| TAW 10-3-UN | 35.90 |
| PolyFox PF-3320 | 0.61 |
| PolyFox PF-151N | 5.40 |

Mix 30 min until dissolved, then add

| | |
|---|---|
| Example 43 | 9.52 |

Mix well, then add

| | |
|---|---|
| TEOA | 5.53 |

Mix well until warm and smooth, then add the following with excellent
agitation

| | |
|---|---|
| UADDI Water | 128.28 |
| Mix well | |
| Filter 150 mesh | |
| pH | 7.48 |
| Viscosity, RVDVE, sp6, 80 F. | 50 rpm - 5620 cps |
| | 100 rpm - 4020 cps |
| Stability - 6 days at 49 C. | Product appears uniform; there may |
| | have been just a slight amount of |
| | layering at the top. |
| | pH - 7.12 |
| | viscosity - 50 rpm - 2850 cps |
| | 100 rpm - 2380 cps |

We then evaluated the oven aged sample versus the non oven aged sample for let down with water and sprayability. The results are shown in the following table.

### Examples 45 and 46

### Coating Development and Comparison of Oven Aged Example 44 Versus Non-Oven Aged Example 44

| Item | Example 45 | Example 46 |
|---|---|---|
| Example 44 Non-Oven | 74.33 | |
| Aged | | |
| Example 44 Oven Aged | | 74.33 |

Add the following under agitation using propeller blade

| | | |
|---|---|---|
| Irgacure 500 | 1.68 | 1.68 |

Mix 5 min then add the following very slowly

| | | |
|---|---|---|
| DI Water | 1.67 | 1.67 |
| DI Water | 24.58 | 24.58 |
| Then add | | |
| DI Water | 14.84 | 14.84 |
| Dynol 604 | 1.27 | 1.27 |
| Surfynol FS 85 | 1.54 | 1.54 |
| BYK 333 | 1.03 | 1.03 |
| pH | 7.20 | 7.29 |
| Visc, #2Zahn, sig., sec, | 14.45 | 13.89 |
| 72 F. | | |
| Sprayability | Excellent | Excellent |
| Flow | 1 crater | 2-3 craters |
| Cure | Excellent | Excellent |
| Film appearance | Clear, glossy | Clear, glossy |

### Example 47

### Styrene Allyl Alcohol Solution

Example 47. Styrene Allyl Alcohol Solution

| Item | Wt/grams |
|---|---|
| Methyl N-amyl Ketone | 120 |
| SAA 100 | 180 |

Mix until dissolved

### Example 48

### Aqueous 2 k AntiGraffiti Resin/Polyol

Example 48. Aqueous Dispersion of AntiGraffiti Resin

| Item | Wt/grams |
|---|---|
| Example 43 | 126.00 |
| Example 47 | 60.32 |
| Doresco TA-138-4 | 48.50 |
| PolyFox PF-151N | 18.0 |
| PolyFox PF-6520 | 1.50 |
| Mix well, then add | |
| AMP-95 | 1.0 |

Mix well until uniform, and warm, then add very slowly with excellent
agitation

| | |
|---|---|
| UADDI Water | 244.75 |
| Filter, 150 mesh | |
| pH | 4.77 |
| Smooth, uniform dispersion results | |

### Example 49

A 2 component antigraffiti coating was made by mixing 300 grams Example 48 dispersion with 147.42 grams of Tolunate HDT-LV2 Polyisocyanate crosslinker from Rhodia in a mixing vessel. To this mixture was added 44.51 grams of DI water under agitation. The sample was mixed for approximately 2 minutes, and the mixed coating spray applied onto Form WK chart from Leneta company. The coating was allowed to air dry. The resulting crosslinked coating was tack free after 4 days, and resists wetting by a permanent marker after 8 days, with complete marker clean up with MEK in that same time period. Other tests show that improved dry times can be obtained with alternative polyisocyantes (an example being Rhodocoat X EZ-M 501, a product of Rhodia, Cranbury, N.J.), and addition of catalysts to the system. The above example merely serves as one of the many examples of the outstanding antigraffiti results possible with the dispersion presented, and as one of the many examples of both the breadth of types of hydrophobic materials that can be dispersed utilizing the invention and the breadth of types of the many coatings that may be obtained therefrom from the invention.

1. An aqueous dispersion comprising:
(a) a carboxyalkyl cellulose ester
(b) a fluorosurfactant and
(c) a hydrophobic material.

2. The aqueous dispersion of claim 1, wherein the hydrophobic material is one or more selected from the group consisting of a wax, a silicone, a silicone wax, a fluorocarbon, a UV absorber, a photoinitiator, a chlorinated polyolefin, a nonchlorinated polyolefin, a hydroxy-functional polymer, a silanol modified polyol, an acrylic, a polyester, a polyether, an acrylate-functional resin, an acrylated acrylic, an acrylated polyester, an acrylated polyether, an acrylated polyurethane, an acrylated epoxy, an amine-modified acrylated acrylic, an amine-modified polyester, an amine-modified polyether, an unsaturated polyester, an allyl-functional polymer, styrene allyl alcohol, a non-water soluble polyol, an air-oxidizable initiator/crosslinker, a phenoplast resin, a hydrocarbon resin, a polyvinyl butyral resin, a polybutadiene resin, a modified polybutadiene resin, an aminoplast resin, an oil, a fat, a fatty acid, a resin derived from an oil, fat, or fatty acid, a plasticizer, a hydroxyl-terminated polybutadiene resin or derivative thereof, a maleic-modified resin, an ethylene vinyl acetate copolymer, a styrene-butadiene copolymer, a styrene-isoprene copolymer, an acrylic copolymer, an alkyd resin, a modified alkyd resin including styrene, vinyl toluene and urethane-modified alkyds, a fluorinated acrylic, and an aliphatic or aromatic hydrocarbon resin.

3. The aqueous dispersion of claim 1, wherein the carboxyalkyl cellulose ester is one or more selected from the group consisting of carboxymethyl cellulose butyrate, carboxymethyl cellulose propionate, carboxymethyl cellulose acetate butyrate, and carboxymethyl cellulose acetate propionate.

4. The aqueous dispersion of claim 1, wherein the fluorosurfactant is one or more selected from the group consisting of a polyoxetane fluorosurfactant and a fluoroaliphatic polymeric ester based surfactant.

5. The aqueous dispersion of claim 1, wherein the aqueous dispersion also comprises C-11 ketone.

6. The aqueous dispersion of claim 1, wherein the aqueous dispersion also comprises a surfactant.

7. The aqueous dispersion of claim 6, wherein the surfactant is one or more selected from the group consisting of acetylenic glycol based surfactants, aliphatic alcohol ethoxylates, alkylphenol ethoxylates, tristyrylphenol ethoxylates, and block copolymers.

8.-20. (canceled)

21. An article coated with a composition comprising the aqueous dispersion of claim 1.

22.-50. (canceled)

51. An aqueous dispersion comprising (a) a water dispersible resin and (b) a hydrophobic material.

52. The aqueous dispersion of claim 51, wherein the hydrophobic material is one or more selected from the group consisting of a wax, a silicone, a silicone wax, a fluorocarbon, a UV absorber, a photoinitiator, a chlorinated polyolefin, a nonchlorinated polyolefin, a hydroxy-functional polymer, a silanol modified polyol, an acrylic, a polyester, a polyether, an acrylate-functional resin, an acrylated acrylic, an acrylated polyester, an acrylated polyether, an acrylated polyurethane, an acrylated epoxy, an amine-modified acrylated acrylic, an amine-modified polyester, an amine-modified polyether, an unsaturated polyester, an allyl-functional polymer, styrene allyl alcohol, a non-water soluble polyol, an air-oxidizable initiator/crosslinker, a phenoplast resin, a hydrocarbon resin, a polyvinyl butyral resin, a polybutadiene resin, a modified polybutadiene resin, an aminoplast resin, an oil, a fat, a fatty acid, a resin derived from an oil, fat, or fatty acid, a plasticizer, a hydroxyl-terminated polybutadiene resin or derivative thereof, a maleic-modified resin, an ethylene vinyl acetate copolymer, a styrene-butadiene copolymer, a styrene-isoprene copolymer, an acrylic copolymer, an alkyd resin, a modified alkyd resin including styrene, vinyl toluene and urethane-modified alkyds, a fluorinated acrylic, and an aliphatic or aromatic hydrocarbon resin.

53. The aqueous dispersion of claim 51, wherein the water dispersible resin comprises an olefinic copolymer.

54. The aqueous dispersion of claim 53, wherein the olefinic copolymer is one or more selected from the group consisting of hydroxyl functional acrylics and polyesters having hydrophilizing functionality.

55. The aqueous dispersion of claim 53, wherein the olefinic copolymer has an average molecular weight of from about 1000 to about 50000, an acid number of from about 15 to about 150 mg KOH/g resin, and an amount of hydroxyl groups of from about 2.5 wt % to about 6 wt %.

56. The aqueous dispersion of claim 52, wherein the aqueous dispersion additionally comprises a fluorosurfactant.

57. The aqueous dispersion of claim 56, wherein the fluorosurfactant is one or more selected from the group consisting of a polyoxetane fluorosurfactant and a fluoroaliphatic polymeric ester based surfactant.

58. The aqueous dispersion of claim 52, wherein the aqueous dispersion additionally comprises C-11 ketone.

59. The aqueous dispersion of claim 52, wherein the aqueous dispersion also comprises a surfactant.

60. The aqueous dispersion of claim 59, wherein the surfactant is one or more selected from the group consisting of acetylenic glycol based surfactants, polyalkylene glycol ethers, aliphatic alcohol ethoxylates, alkylphenol ethoxylates, tristyrylphenol ethoxylates, and block copolymers.

61.-81. (canceled)

82. The aqueous dispersion of claim 51, wherein the aqueous dispersion additionally comprises a carboxyalkyl cellulose ester.

83. The aqueous dispersion of claim 82, wherein the carboxyalkyl cellulose ester is one or more selected from the group consisting of carboxymethyl cellulose butyrate, carboxymethyl cellulose propionate, carboxymethyl cellulose acetate butyrate, and carboxymethyl cellulose acetate propionate.
